(19) United States
(12) Patent Application Publication
(10) Pub. No.: US 2011/0282801 A1
(43) Pub. Date: Nov. 17, 2011

(54) RISK-SENSITIVE INVESTMENT STRATEGIES UNDER PARTIALLY OBSERVABLE MARKET CONDITIONS

(75) Inventor: Janusz Marecki, Yorktown Heights, NY (US)

(73) Assignee: INTERNATIONAL BUSINESS MACHINES CORPORATION, Armonk, NY (US)

(21) Appl. No.: 12/780,650

(22) Filed: May 14, 2010

(51) Int. Cl. G06Q 40/00

(52) U.S. Cl. 705/36 R

(57) ABSTRACT

System, method and computer program product for modelling Risk-Sensitive Partially-Observable Markov Decision Processes (POMDPs), e.g., in a high-risk domain such as financial planning and solving such equations exactly, such that agents maximize the expected utility of their actions. The system and method employs an exact algorithm for solving Risk-Sensitive POMDPs, for piecewise linear utility functions, by representing underlying value functions with sets of piecewise bilinear functions—computed using functional value iteration—and pruning the dominated bilinear functions using efficient linear programming approximations of underlying non-convex bilinear programs. Considering piecewise linear approximations of utility functions, (i) there is defined the Risk-Sensitive POMDP model that incorporates value functions V(b,w) where argument “b” is a belief state and argument “w” is a continuous wealth dimension; (ii) derive the fundamental properties of the underlying value functions and provide a functional value iteration technique to compute them; and (iii) determine the dominated value functions, to speed up the algorithm.

### STATEMENT REGARDING FEDERALLY SPONSORED RESEARCH OR DEVELOPMENT

The U.S. Government has a paid-up license in this invention and the right in limited circumstances to require the patent owner to license others on reasonable terms as provided for by the terms of Contract. No. W911NF-06-3-0001 awarded by the United States Army.

### FIELD OF INVENTION

The present invention relates generally to financial planning and investing, and particularly, to a system and method for devising investment strategies and determining an optimal investment strategy in accordance with an expected risk sensitivity at a particular point in time.

### BACKGROUND

Recent years have seen an unprecedented rise of interest in decision support systems that help investors to choose an investment strategy to maximize their returns. In particular, Partially Observable Markov Decision Processes (POMDPs) (see, e.g., E. J. Sondik, entitled The Optimal Control of Partially Observable Markov Processes, Ph.D Thesis, Stanford University, 1971) have received a lot of attention due to their ability to provide multistage strategies that address the uncertainty of the investment outcomes and the uncertainty of market conditions head-on.

Yet, POMDP solvers (see, e.g., M. Hauskrecht, entitled Value-function approximations for POMDPs, JAIR, 13:33-94, 2000; Z. Feng and S. Zilberstein entitled Region-based incremental pruning for POMDPs in UAI, pages 146-15, 200; and, J. Pineau, G. Gordon, and S. Thrun entitled PBVI: An anytime algorithm for POMDPs, IJCAI, pages 335-344, 2003) typically maximize the expected utility of the investments. In contrast, in high-stake domains such as financial planning, it is often imperative to find an optimal investment strategy that maximizes the expected “utility” of the investments, for non-linear utility functions that characterize the investor attitude towards risk. While there has been demonstrated how to solve multistage stochastic optimization problems where risk-sensitivity is expressed via utility functions, this was only for problems characterized by fully observable market conditions.

It would be highly desirable to provide a system and method that enables the generation of a theoretic model for risk-sensitive financial planning under partially observable market conditions and the solution of such model that accounts for risk sensitivity.

Currently, there are no algorithms known in the art that can provide an optimal POMDP solution that accounts for risk sensitivity.

It would be highly desirable to provide a system and method that enables the generation of a theoretic model for risk-sensitive financial planning under partially observable market conditions and the solution of such model that accounts for risk sensitivity.

### SUMMARY

The present invention addresses the above-mentioned shortcomings of the prior art approaches by first defining Risk-Sensitive POMDPs, and generating a novel decision theoretic model for risk-sensitive financial planning under partially observable market conditions.

In one aspect, by considering piecewise linear approximations of utility functions, the method implements a functional value iteration method using a “solver” to solve Risk-Sensitive POMDPs optimally by computing the underlying value functions exactly, through the exploitation of their piecewise bilinear properties. In one aspect, the value functions are derived analytically using a Functional Value Iteration algorithm.

Further to this aspect, to speed up the implemented Risk-Sensitive POMDPs solver, the system and method performs finding and pruning the dominated investment strategies using efficient linear programming approximations to the underlying non-convex bilinear programs. That is, by deriving the fundamental properties of the underlying value functions, the method provides a functional value iteration technique to compute them exactly, and further, provides an efficient procedure to determine the dominated value functions, to speed up the algorithm.

In one aspect, there is provided a system, method and computer program product for determining an investment strategy for a risk-sensitive user. The method comprises: modeling an user's attitude towards risk as one or more utility functions, the utility functions, the utility function transforming a wealth of the user into a utility value; generating a risk-sensitive Partially Observable-Markov Decision Process (PO-MDP) based on the one or more utility functions; and, implementing Functional Value Iteration for solving the risk sensitive PO-MDP, the solution determining an action or policy calculated to maximize an expected total utility of an agent's actions at a particular point in time acting in a partially observable environment.

Further to this aspect, the generating of the risk-sensitive PO-MDP comprises: generating an expected utility function V_{U}ⁿ(b,w) for 0≦n≦N,b∈B,w∈Wⁿ where Wⁿ denotes the set of all possible user wealth levels in decision epoch n; and, maximizing the expected utility function V_{U}ⁿ(b,w) for a user when commencing action a∈A, where A is a set of Actions, in decision period n in a belief state b with a wealth level w.

In a further aspect, there is provided a system for determining an investment strategy for a risk-sensitive user comprising: a memory; a processor in communications with the memory, wherein the system performs a method comprising: modeling an user's attitude towards risk as one or more utility functions, the utility functions the utility function transforming a wealth of the user into a utility value; generating a risk-sensitive Partially Observable-Markov Decision Process (PO-MDP) based on the one or more utility functions; and, implementing Functional Value Iteration for solving the risk sensitive PO-MDP, the solution determining an action or policy calculated to maximize an expected total utility of an agent's actions at a particular point in time acting in a partially observable environment.

A computer program product is provided for performing operations. The computer program product includes a storage medium readable by a processing circuit and storing instructions run by the processing circuit for running a method. The method is the same as listed above.

### BRIEF DESCRIPTION OF THE DRAWINGS

The objects, features and advantages of the present invention will become apparent to one skilled in the art, in view of the following detailed description taken in combination with the attached drawings, in which:

FIG. 1 an example problem set-up for planning under uncertainty, e.g., in a financial planning domain, by incorporating risk sensitive planning in partially observable domains;

FIGS. 2A-2C depict a methodology 100 employed for devising an optimal single or multi-stage investment strategy in one example;

FIG. 3 depicts example utility functions that may be constructed to represent a particular entity's attitude toward risk in an example embodiment;

FIG. 4A depicts in an example implementation results 350 showing a plot of epsilon ε (plotted on the x-axis) vs. runtime (e.g., in seconds on a logarithmic scale), and vs. the solution quality (plotted on the y-axes) in example results 360 shown in FIG. 4B;

FIG. 5 depicts conceptually use of functional value iteration technique 375 for solving Risk-Sensitive POMDPs to provide action(s) designed to achieve a maximized expected utility at an example chosen decision epoch;

FIG. 6 is a visual representation of the set-up problem (S, A, P, O, R, Z, U) of the risk sensitive PO_MDP model 200;

FIG. 7 graphically depicts example solver results 220 that can be used for extracting an agent policy, e.g., an investment action to perform;

FIG. 8 graphically depicts solver results for example strategies (e.g., two different actions) as two example value functions 275a, 275b to maximize an expected utility based on proposed strategy.

FIG. 9 illustrates an exemplary hardware configuration for implementing the flow charts depicted in FIGS. 2A- 2C in one embodiment.

### DETAILED DESCRIPTION

In one aspect, there is provided a system, method and computer program product that provides and solves for a Risk-sensitive investor, an optimal investment strategy. In one embodiment, the system and method allows for Multistage investment strategies. The system and method operates to estimate market state from noisy observations, and, handles partially observable market states. Thus, in one aspect, to estimate the market state from noisy observations, the method of the invention employs modeling the data as a Partially Observable Markov Decision Process (PO-MDP).

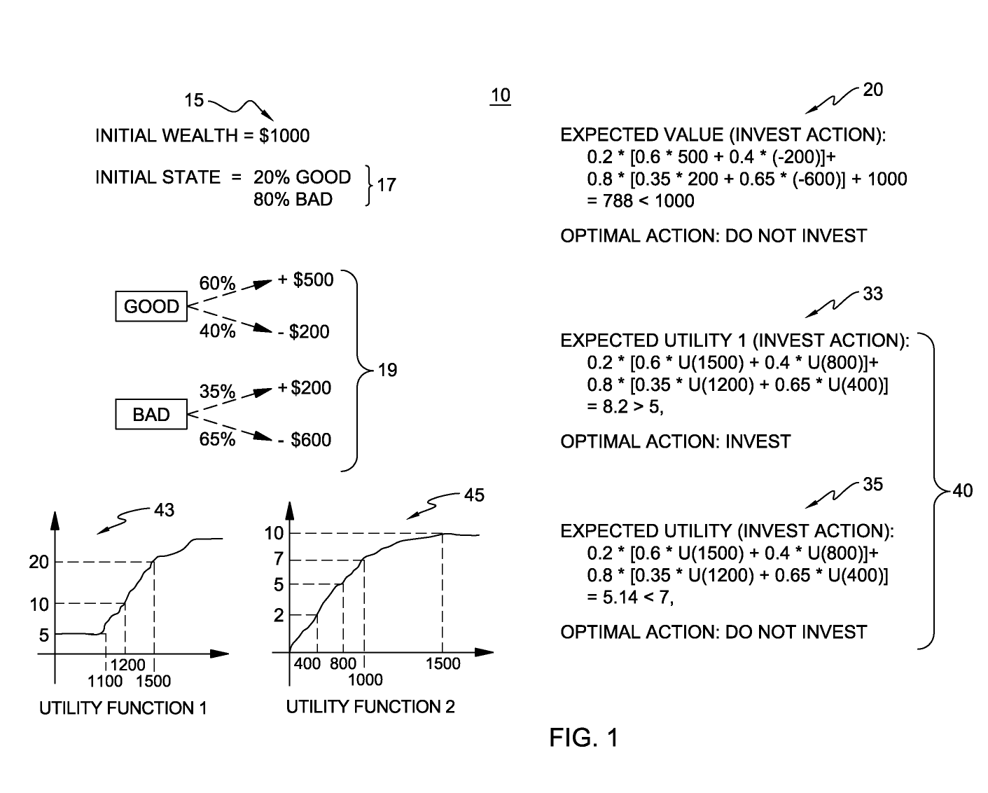

FIG. 1 provides an illustrative example of a problem 10 set-up for planning under uncertainty in partially observable domains, for instance, in a financial planning domain, by incorporating risk sensitive planning in partially observable domains. In the example, a decision is to be made as to whether to invest the current wealth 15, e.g., $1000. This decision has to be made considering that the state of the market 17 is uncertain, e.g., depicted as a probability of being in either of two market states 19, e.g., and comprising a value 20% good, and 80% bad, and the return on investment is also uncertain. FIG. 1 provides further details on this example setting and, for purposes of explanation, focus is made on a single decision. However, the invention is applicable to general problems where a sequential set of decisions need to be made.

In one embodiment, there are two ways to make decisions in such settings: (a) Expected value maximization 20 which is the risk neutral way to make decisions, i.e., by not considering that people have various attitudes towards risk. Thus, there is always the same decision made by this method. As shown in FIG. 1, maximizing expected value provides a decision to not invest 25; (b) Expected utility maximization 40 which mechanism is sensitive to the risk attitude of the person and as shown, depending on whether the person is risk seeking 33 (as indicated from utility function 43 ), or risk averse 35 (as indicated from utility function 45 ) which depicts a slower rate of utility for the same wealth, the decision appropriately changes. For example, the options may result in a decision to invest (e.g., in a good market) or may result in a decision to not invest (e.g., in a bad market). The invention answers given the expected wealth and stated market conditions which action or policy to pursue (e.g., given a bad market or good market in the example shown in FIG. 1).

As utility theory defines utility functions as transforming the current wealth of an agent (its initial wealth plus the sum of the immediate rewards it received so far) into a utility value, the shape of the utility function can be used to define the agent attitude towards risk. To compute optimal policies for such risk-sensitive agents, acting in partially observable environments, the finite horizon POMDPs may be solved that maximize the expected total utility of agent actions. On account of being sensitive to risk attitudes, these planning problems are referred to as Risk-Sensitive POMDPs characterized as comprising the following: S is a finite set of discrete states of the process; A is a finite set of agent actions. The process starts in some State s₀∈S and runs for N consecutive decision epochs. In particular, if the process is in state s∈S in decision epoch 0≦n≦N, the agent controlling it chooses an action a∈A to be executed next. The agent then receives the immediate reward R(s,a) while the process transitions with probability P(s′|s,a) to state s′∈S at decision epoch n+1. Otherwise, in decision epoch n=N, the process terminates.

The utility of the actions that the agent has executed is then a scalar

U(w₀+Σₙ₌₀^{N-1}rₙ)

where w₀ is the initial wealth of the agent, U is the agent utility function and rₙ is the immediate reward that the agent received in decision epoch n. The goal of the agent is to devise a policy π that maximizes its total expected utility:

E[U(w₀+Σₙ₌₀^{N-1}rₙ)|π].

What further complicates the agent's search for policy “π” is that the process is only partially observable to the agent. That is, the agent receives noisy information about the current state s∈S of the process and can therefore only maintain the current probability distribution b(s) over states s∈S (referred to as the agent belief state). When the agent executes some action a∈A and the process transitions to state s′, the agent receives with probability O(z|a, s′) an observation z from a finite set of observations Z. The agent then uses z to update its current belief state b, as will be described in greater detail herein below. In the following, B denotes an infinite set of all possible agent belief states and b₀∈B is the agents' starting belief state (e.g., unknown at the planning phase).

Additionally, W:=∪_{0≦n≦N}Wⁿ is the set of all possible agent wealth levels where Wⁿ denotes the set of all possible agent wealth levels in decision epoch n. For the initial range of agent wealth levels W⁰:=[w⁰, w̅⁰] there is determined Wⁿ=[wⁿ, w̅ⁿ] where wⁿ=wⁿ⁻¹+min_{s∈S,a∈A}R(s,a) and w̅ⁿ= w̅ⁿ⁻¹+max_{s∈S,a∈A}R(s,a), for n=1, . . . ,N. It is noted that W⁰⊂W¹⊂ . . . ⊂W^{N}. A policy π of the agent therefore indicates which action π(n,b,w)∈A the agent should execute in decision epoch n, belief state b, with wealth level w, for all 0≦n≦N , b∈B , w∈Wⁿ.

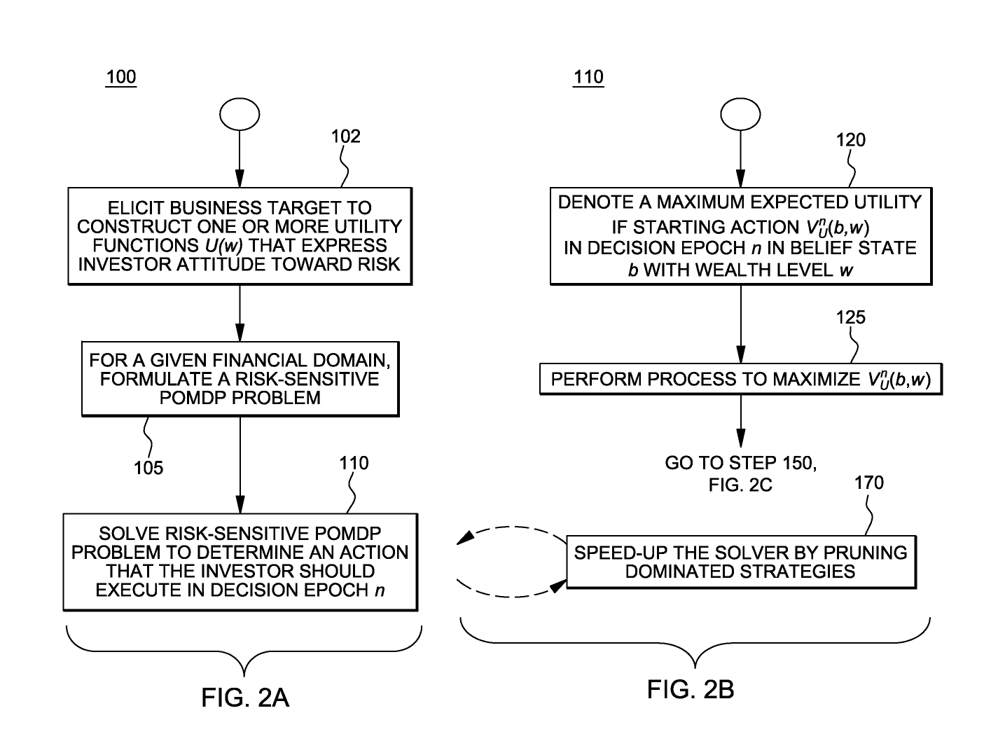

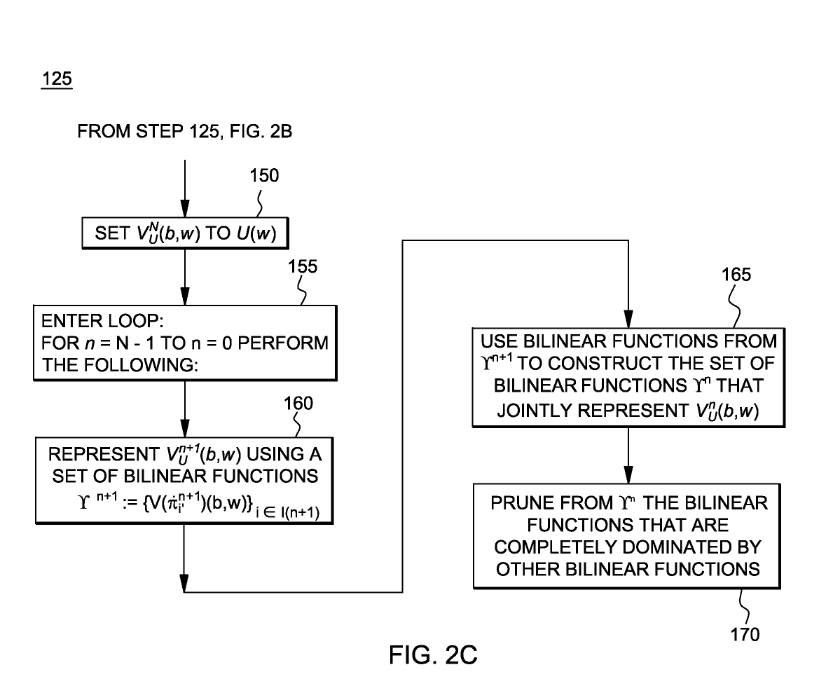

FIGS. 2A-2C provide a methodology 100 for devising an optimal single or multi-stage investment strategy. The method may be run in a computer or like processing device and a suitable storage media, e.g., a computer program product, may include instructions configured for devising an optimal single or multi-stage investment strategy.

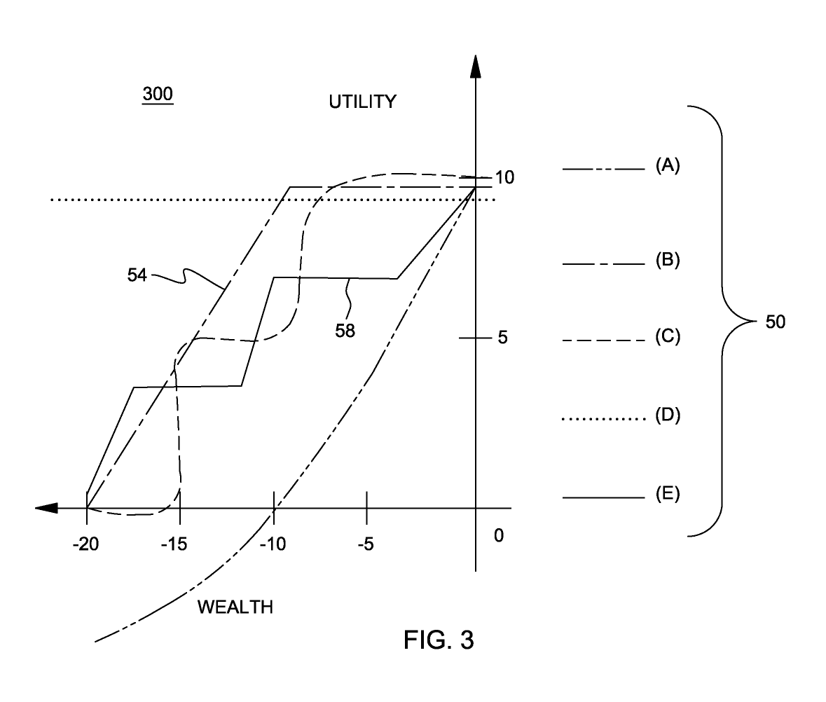

In the method 100 for providing or devising an optimal single or multi-stage investment strategy, at 102, an entity, a user, a business organization, a business target, an agent, to construct one or more utility functions. These utility functions are of a shape that can represent the user, e.g., agent's, attitude towards risk and the PO-MDPs solver framework is used to maximize the expected total utility (as opposed to expected total reward) of agent actions. For purposes of illustration, FIG. 3 shows several example utility functions labeled 50A-50E constructed by an entity, e.g., a user, a business organization, etc., that depicts a particular user's or business unit's attitudes toward risk with each function depicted as a plot of perceived expected value or figure of merit (e.g. (utility) vs. potential wealth accumulation. For example, utility function 54, a continuous function, U(w), is a plot depicting an example situation where the company sets a target to accumulate wealth of −10 or better (more), as there is perceived no extra utility in getting more money. However, in example utility function 58 that a company may construct, there may be three (3) targets (stages) indicated: e.g., to obtain a target wealth of, e.g., −17 or more, obtain a target wealth −10 or more, or −3 or more.

In the set-up of the PO_MDP, the elicited utility function(s) U(w) that express the investor's attitude towards risk by mapping all attainable wealth levels w to their utility, as perceived by a user, e.g., an investor, an agent, for example, are input to a computer or like processing device such as described with respect to FIG. 9 for processing thereof.

As shown in FIG. 2A, at 105, for a given financial domain, the method formulates a Risk-Sensitive PO_MDP problem.

Then, this Risk-Sensitive POMDP is solved. That is, there is determined what action (policy) a∈A should the investor execute in decision epoch n∈[0, 1, . . . , N], with wealth level w∈[wₘᵢₙ, wₘₐₓ], if the investor believes that the probability that the market is in state s is b(s), for all s∈S. As shown in FIG. 2A, in another aspect, the solver implemented in generating the solution to the PO_MDP may be accelerated (speed-up) at 170 by pruning dominated strategies as will be described in greater detail hereinbelow.

The processing at 110, FIG. 2A is now described in view of FIG. 2B processing where, in order to perform step 110, there is performed: at step 120, the generation of the expected utility function V_{U}ⁿ(b,w) to be maximized for the investor if investor starts acting in decision epoch n in belief state b (distribution over states s∈S) with wealth level w. Then, at 125, the V_{U}ⁿ(b,w) function is maximized by executing an action π*(n,b,w) that is computed in accordance with equation 1) as follows:

$$arg {max}_{a ∈ A} \{ {\sum }_{z ∈ Z} P ( z \vert b , a ) {V}_{U}^{n + 1} ( T ( b , a , z ) , w + R ( b , a ) ) \} \qquad 1 )$$

where P(z|b,a)=Σ_{s′∈S}O(z|a, s′)Σ_{s∈S}P(s′|s,a)b(s) is the probability of observing z after executing action a from belief state b, R(b,a):=Σ_{s∈S}b(s)R(s,a) is the expected immediate reward that the agent will receive for executing action a in belief state b and T(b,a,z) is the new belief state of the agent after executing action a from belief state b and observed z. Formally, for each s′∈S it holds that:

T(b,a,z)(s′)=[O(z|a,s′)/P(z|b,a)]Σ_{s∈S}P(s′s,a)b(s).

Hence, to find the optimal policy, π*, value iteration is employed to calculate values V_{U}ⁿ(b,w) for all 0≦n≦N, b∈B,w∈Wⁿ. Value iteration calculates these values for n=N,N−1, . . . ,0. Specifically, as follows from step 150, FIG. 2C, for n=N the process terminates and thus:

V_{U}^{N}(b,w)=U(w) 2)

for all w∈Wⁿ, b∈B. Otherwise, for all 0≦n≦N,

$${V}_{U}^{n} ( b , w ) == {max}_{a ∈ A} \{ {\sum }_{z ∈ Z} P ( z \vert b , a ) {V}_{U}^{n + 1} ( T ( b , a , z ) , w + R ( b , a ) ) \} \qquad 3 )$$

for all b∈B and w∈Wⁿ. In the following, values of V_{U}ⁿ(b,w) are grouped over all (b,w)∈B×W into value functions V_{U}ⁿ:B×W→ [symbol] , for each 0≦n≦N. Note, that computing value functions V_{U}ⁿ from value functions V_{U}ⁿ⁺¹ exactly is difficult because B and W are infinite. In addition, POMDP solution techniques that already handle an infinite B—are not applicable for solving Risk-Sensitive POMDPs as they do not handle an infinite W.

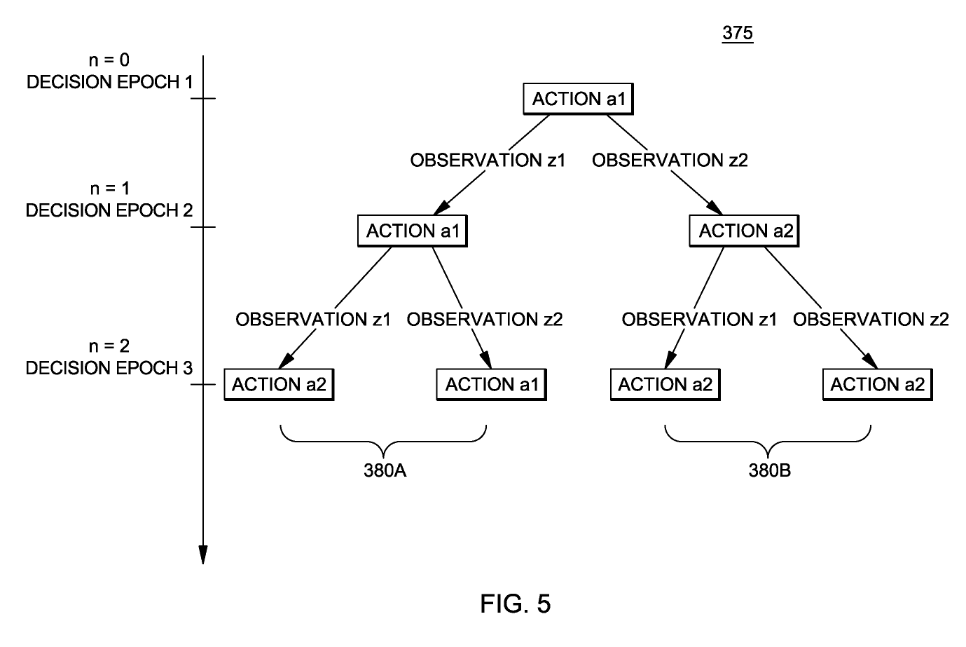

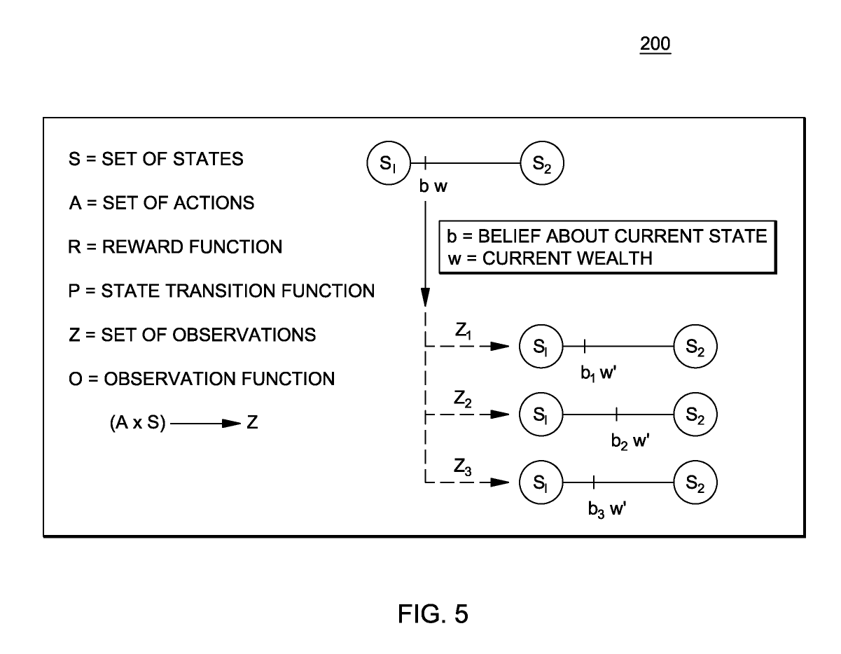

The functional value iteration technique for solving Risk-Sensitive POMDPs exactly is now described according to one embodiment. This technique backs up utility functions (unlike just reward values in value iteration) defined on the wealth over the entire time horizon. The method iteratively constructs the finite partitioning of the B×W search space into regions where the value functions can be represented with point based policies, a point based policy being a mapping from the observations received so far to an action that should be executed next. For example, as shown in FIG. 5, using functional value iteration technique 375 for solving Risk-Sensitive POMDPs, there is depicted conceptually an example point based policy 380 resulting from performing actions and observing over 3 decision epochs (n=2) two possible observations z1, z2. In the example depiction, the point based policy 380a determines for the third epoch n=2 a policy of actions A1, A2 dependent upon the observations (z1, z2) resulting from performing action A1 in decision epoch n=1, or a point based policy 380b determined for the third epoch n=2 an action A2 dependent upon the observations (z1, z2) resulting from performing action A2 in prior decision epoch n=1.

In one embodiment, if there is only two states, then a belief state b belongs to a set [0,1] =B; a wealth interval on the other hand is [Wₘᵢₙ,W,ₘₐₓ]=W. Thus, a “whole” region is B×W can be partitioned in multiple ways, e.g., into four sub-regions:

[0,0.5]×[Wₘᵢₙ, (Wₘᵢₙ+Wₘₐₓ)/2]

[0,0.5]×[Wₘᵢₙ+Wₘₐₓ)/2, Wₘₐₓ]

[0.5,1]×[Wₘᵢₙ, (Wₘᵢₙ+Wₘₐₓ)/2]

[0.5,1]×[Wₘᵢₙ+W_{max )/}2, W_{max ]}

To this end, Zⁿ is denoted as a set of agent observation histories of length less than “n”. Also, for each decision epoch 0≦n≦N, there is defined a point based policy \dot{π}ⁿ as a function

\dot{π}ⁿ:Z^{N-n}→A 4)

and the expected utility to go of \dot{π}ⁿ at some belief state and wealth level pair (b,w)∈B×Wⁿ as a value (i.e., a function over B×Wⁿ) set forth according to equation 5 ) as follows:

$$υ 〈 {\dot{π}}^{n} 〉 ( b , w ) := E [ U ( w + {\sum }_{{n}^{′} = n}^{N - 1} {r}_{{n}^{′}} ) \vert {\dot{π}}^{n} , {b}_{0} = b ] ) . \qquad 5 )$$

Letting {\dot{π}ᵢⁿ}_{i∈I(n)} be a collection of point-based policies such defined, for a decision epoch n, then any policy π can be represented as some (possibly infinite) collection of point-based policies. For example, to represent n in decision epoch n, a different point-based policy \dot{π}ᵢⁿ may be maintained for each (b,w)∈B×Wⁿ. In particular, to represent π* in decision epoch n, there may be maintained a different point-based policy argmax_{\dot{π}}_{ᵢ}_{ⁿ}υ [symbol] \dot{π}ᵢⁿ [symbol] (b,w) for each (b,w)∈B×Wⁿ. A finite collection {\dot{π}ᵢⁿ}_{i∈I(n)} is sufficient to represent π*, for each 0≦n≦N. That is, there exists a finite partitioning {Yᵢⁿ}_{i∈I(n)} of B×Wⁿ and a finite collections {\dot{π}ᵢⁿ}_{i∈I(n)} such that υ [symbol] \dot{π}ᵢⁿ [symbol] (b,w)=V_{U}ⁿ(b,w) for all (b,w)∈Yᵢⁿ.

In one aspect of the invention, finite collections {\dot{π}ᵢⁿ}_{i∈I(n)} for 0≦n≦N that represent π* are computed. The technique of the invention approximates that the utility function U(w) is piecewise linear over w∈W^{N} (or, that it has already been approximated with a piecewise linear function with a desired accuracy). Specifically, given that there exists wealth levels w^{N}=w₁<. . . <w_{K}= w̅^{N} and pairs of constants (C₁, D₁), . . . (C_{K},D_{K}) such that U(w)=Cₖw+Dₖ for all w∈[wₖ,wₖ₊₁) over all 1≦k≦K.

According to the invention, for such U, as is proven by induction analysis, the following holds for all 0≦n≦N:

1. The value function V_{U}ⁿ is represented by a finite set of functions {υ [symbol] \dot{π}ᵢⁿ [symbol] }_{i∈I(n)}. That is, there exists a partitioning {Yᵢⁿ}_{i∈I(n)} of B×Wⁿ and a set of point-based policies {\dot{π}ᵢⁿ}_{i∈I(n)} such that for all (b,w)∈B×Wⁿ there exists i∈I(n) such that (b,w)∈Yᵢⁿ and V_{U}ⁿ(b,w)=υ [symbol] \dot{π}ᵢⁿ [symbol] (b,w)=max_{i′∈I(n)}υ [symbol] \dot{π}ᵢⁿ [symbol] (b,w).
2. For all i∈I(n), υ [symbol] \dot{π}ᵢⁿ [symbol] is piecewise bilinear. That is, there exists a finite partitioning {B×W_{i,k}ⁿ}_{k∈I(n,i)} of B×Wⁿ such that W_{i,k}ⁿ is a convex set and for all (b,w)∈B×W_{i,k}ⁿ, υ [symbol] \dot{π}ᵢⁿ [symbol] ^{(b,w)=Σ}_{s∈S}b(s)(c_{i,k,s}ⁿw+d_{i,k,s}ⁿ), for all k∈I(n,i);
3. For all i∈I(n), υ [symbol] \dot{π}ᵢⁿ [symbol] can be derived from the set of functions {υ [symbol] \dot{π}_{i′}ⁿ⁺¹ [symbol] }_{i′∈I(n+1)}.

### Induction Analysis

As part of reduction analysis, induction holds for n+1 and it also holds for n. To this end, from Equation (3), as V_{U}ⁿ(b,w) is calculated by:

$${max}_{a ∈ A} \{ {\sum }_{z ∈ Z} P ( z \vert b , a ) {V}_{U}^{n + 1} ( T ( b , a , z ) , w + R ( b , a ) ) \}$$

which calculation is broken into five stages:

First, as shown in the Appendix, there is calculated, in a first stage,
V̅_{U,a,z}ⁿ(b,w):=V_{U}ⁿ⁺¹(T(b,a,z),w) where V_{U}ⁿ⁺¹ is represented by {υ [symbol] \dot{π}ᵢⁿ⁺¹ [symbol] }_{i∈I(n+1)} from the induction assumption. Then, in a second stage, there is derived
V̅_{U,a,z}ⁿ(b,w):=P(z|b,a)V_{U,a,z}(b,w) and then, in a third stage,
V_{U,a}ⁿ(b,w):=Σ_{z∈Z} V̅_{U,a,z}ⁿ(b,w). Then, at a fourth stage, there is derived
V̅_{U,a}ⁿ(b,w):=V_{U,a}ⁿ(b,w+R(b,a)). The proof of the induction step is concluded at a fifth stage by calculating V_{U}ⁿ(b,w):=max_{a∈A} V̅_{U}ⁿ(b,w) where V_{U}ⁿ is represented by {υ [symbol] \dot{π}ᵢⁿ [symbol] }_{i∈I(n)}.

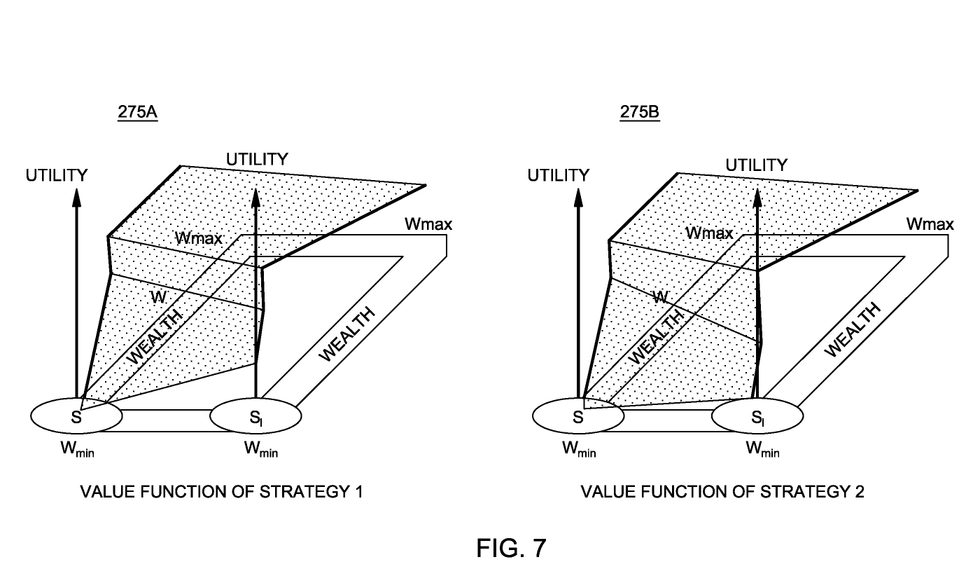

Thus, as shown in FIG. 7, the Functional Value Iteration technique for solving the Risk-sensitive PO-MDP exactly, results in a solution set of value functions for each decision stage “n” (the solution is defined for all decision epochs n=1 , . . . ,N). By considering piecewise linear approximations of utility functions (FIG. 3), the functional value iteration method solves Risk-Sensitive POMDPs optimally by computing the underlying solution set of value functions exactly, through the exploitation of their piecewise bilinear properties.

Referring to FIG. 2C, there is depicted a methodology 150 for solving the underlying value functions exactly through the exploitation of their piecewise bilinear properties. As shown at step 150, there is depicted a first step of setting V_{U}^{N}(b,w) equal to the maximum expected utility U(w) for the investor if its starts acting in decision epoch n in belief state b (distribution over states s∈S) with wealth level w. The process enters an iterative loop at step 155, for example, a “for” loop setting iterations for each decision epoch s n=N−1 to n=0, for example. At each decision epoch n=N−1 to n=0 the following is performed: 1) at 160, FIG. 2A, representing V_{U}ⁿ⁺¹(b,w) using a set of bilinear functions γⁿ⁺¹:={ [symbol] \dot{π}ᵢⁿ⁺¹ [symbol] (b,w) }_{i∈I(n+1).} Then, at 165, the bilinear functions from γⁿ⁺¹ are used to construct the set of bilinear functions γⁿ that jointly represent V_{U} ⁿ(b,w).

The operation to construct the set of bilinear functions γⁿ is performed by a Linear/Integer program “solver”, such as ILOG CPLEX™ available from International Business Machines, Inc.) embodied by a programmed computing system (e.g., a computing system 400 as shown in FIG. 9). Particularly, the inputs to the solver are:

N=The number of decision epochs;
U=The agent utility function(s) that maps the agent wealth w to its utility; U(w) is a piecewise linear approximation of an arbitrary utility function elicited from a user, e.g., an investor and is specified by constants Cₖ, and Dₖ, k=1, . . . , K, as explained in greater detail herein below.

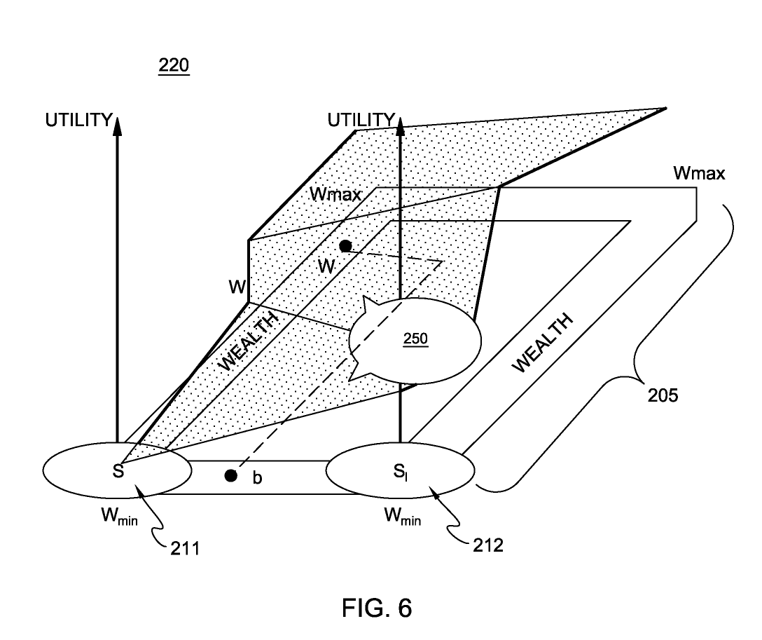

As shown in FIG. 6, the set-up problem (S, A, P, O, R, Z, U) of the POMDP model 200 comprises the following:
S=the set of states; for example, S={s1,s2} where s1 denotes a “market is bad” state and s2 denotes “market is good” state. There can be more than two states, e.g., if a state describes multiple markets (that can be good/bad);
A=the set of actions (e.g. invest/do not invest in company X/Y/Z etc.);
P=the state to state transition function;
Z=the set of observations;
O=the observation function; and,
R=the reward function.

An example data structure to represent these solver inputs is therefore a tuple (N,U,S,A,P,Z,O,R) where N is an integer, U is a piecewise linear function on domain (min_wealth, max_wealth), S,A,O are binary vectors to give unique identifiers to states, actions and observations respectively. P:S×A×S →[0,1] is a state to state transition function, O:S×A×Z→[0,1] is an observation function and R:S×A→[reward_min, reward_max] is a reward function.

The equations for processing these inputs by the solver are programmed into the solver and are computed according to the proof by induction provided in the Appendix. Additionally, the solver proceeds by computing the value functions Vⁿ(b,w) starting from n=N, then n=N−1, . . . , and finally n=0. As soon as V⁰(b,w) is found, the agent knows what action to execute in the starting decision epoch.

In solving the equations below, the following are defined:

n is the current epoch;

w is the wealth level;

s denotes some state;

b is a probability distribution over states, i.e., the agent current belief state;

b(s) is a an agent belief that the system is in state s with a certain probability, for all states from the set of states S. As an example, two states, sb and sg are considered such that sb=market is bad, and sg=market is good. Then b=(0.2, 0.8) means that the agent beliefs that the current system state is sg with probability b(sg)=0.2, and that the current system state is sb with probability b(sb)=0.8;

b is a belief variable;

w is a wealth variable;

(b,w) is a feasible solution to the

(b′ , x) is a feasible solution corresponding to (b,w) where (b′:=b,x:=bw);

x=[x(s)],_{s∈S} is a vector.

Program (17) relaxes Program (16b) because for any there exists a corresponding feasible solution (b′:=b,x:=bw)

c and d (or the variations thereof, with various indices) are constants.

V(b,w) is the value function returned by the solver hat is represented using sets of bilinear functions.

The method includes implementing calculations performed by solver. When the algorithm starts, the known constants are the constants Cₖ and Dₖ k=1,2, . . . , K that specify the piecewise linear utility function U (defined in each of the K wealth intervals as a linear function Cₖ w+Dₖ). In the description of the method, auxiliary constants c and d are introduced (as set forth in the staged operations 1,2,3,4,5 in the Appendix).

The method includes:
1. Calculating, by the solver, during a stage 1 calculation, the following equation (19) from Lemma 1, Appendix:

$$\begin{matrix}{υ}_{a , z , i}^{n} ( b , w ) := υ 〈 {\dot{π}}_{i}^{n + 1} 〉 ( T ( b , a , z ) , w ) \\ = {\sum }_{s ∈ S} b ( s ) {\sum }_{{s}^{′} ∈ S} P ( {s}^{′} \vert s , a ) O ( z \vert a , {s}^{′} ) ( {c}_{i , k , {s}^{′}}^{n + 1} w + {d}_{i , k , {s}^{′}}^{n + 1} ) , \\ = {\sum }_{s ∈ S} b ( s ) ( {c}_{a , z , i}^{n , k , s} w + {d}_{a , z , i}^{n , k , s} )\end{matrix}$$

for constants c_{a,z,i}^{n,k,s}Σ_{s′∈S}P(s′|s,a)O(z|a,s′)c_{i,k,s′}ⁿ⁺¹ and, d_{a,z,i}^{n,k,s}Σ_{s′∈S}P(s′|s,a)O(z|a,s′)d _{i,k,s′}ⁿ⁺¹ where these constants c_{a,z,i}^{n,k,s} and d_{a,z,i}^{n,k,s} are obtained by computer system from utility functions, observed data and belief states. For example, constants cⁿ⁺¹_{i,k,s} and dⁿ⁺¹_{i,k,s} are obtained by the computer system from utility functions (when n=N) or, from the previous algorithm iteration (when n<N). This calculation exhibits that function υ_{a,z,i}ⁿ(b,w) from a stage 1 calculation is piecewise bilinear over (b,w)∈B×Wⁿ⁺¹.
2. Calculating, by the solver, during a stage 2 calculation, the following equation (9) from Stage 2, Appendix:

$$\begin{matrix}{\overline{υ}}_{a , z , i}^{n} ( b , w ) := P ( z \vert b , a ) {υ}_{a , z , i}^{n} ( b , w ) \\ = P ( z \vert b , a ) {\sum }_{s ∈ S} b ( s ) ( {c}_{a , z , i}^{n , k , s} w + {d}_{a , z , i}^{n , k , s} ) , \\ = {\sum }_{s ∈ S} b ( s ) ( {\overline{c}}_{a , z , i}^{n , k , s} w + {\overline{d}}_{a , z , i}^{n , k , s} )\end{matrix}$$

for all (b,w)∈B×Wᵢⁿ⁺¹, k∈I(n+1,i) where c̅_{a,z,i}^{n,k,s}=P(z|b,a)c_{a,z,i}^{n,k,s} and d̅_{a,z,i}^{n,k,s}=P(z|b,a)d_{a,z,i}^{n,k,s} are constants.
3.Calculating, by the solver, after a stage 2 calculation, the following equation (21) from Lemma 2, Appendix:

$${υ}_{a , i , k}^{n} ( b , w ) := {\sum }_{s ∈ S} b ( s ) ( {c}_{a , i}^{n , k , s} w + {d}_{a , i}^{n , k , s} ) ,$$

for all (b,w)∈B×Wⁿ⁺¹, where constants c_{a,i}^{n,k,s}:=Σ_{z∈Z} c̅_{a,z,i(z)}^{n,k(z),s}, and d_{a,i}^{n,k,s}:=Σ_{z∈Z} d̅_{a,z,i(z)}^{n,k(z),s}.
4. Calculating, by the solver after a stage 3 calculation, the following equation (24 ) from Lemma 3, Appendix:

$${\overline{υ}}_{a , i , k}^{n} ( b , w ) := {\sum }_{s ∈ S} b ( s ) ( {\overline{c}}_{a , i}^{n , k ( s ) , s} w + {\overline{d}}_{a , i}^{n , k ( s ) , s} ) ,$$

for all (b,w)∈B×Wⁿ, where c̅_{a,i}^{n,k(s),s}:=c_{a,i}^{n,k(s),s} and d̅_{a,i}^{n,k(s),s}:=d_{a,i}^{n,k,(s),s}R(s,a) are constants.
5. Then, calculating, by the solver, the following equation (25 ) from Lemma 3, Appendix:

$$\begin{matrix}{\overline{υ}}_{a , i}^{n} ( b , w ) := {υ}_{a , i}^{n} ( b , w + R ( b , a ) ) \\ = {\sum }_{s ∈ S} b ( s ) ( {\overline{c}}_{a , i}^{n , k ( s ) , s} w + {\overline{d}}_{a , i}^{n , k ( s ) , s} ) \\ = {\overline{υ}}_{a , i , k}^{n} ( b , w )\end{matrix}$$

6. Finally, there is calculated by the solver, a calculation of the following equation (15) from Stage 5, Appendix:

$$\begin{matrix}{V}_{U}^{n} ( b , w ) := {max}_{( a , i ) ∈ I ( n )} {\overline{υ}}_{a , i}^{n} ( b , w ) \\ ≡ υ 〈 {\dot{π}}_{( a , i )}^{n} 〉 ( b , w )\end{matrix}$$

Therefore, V_{U}^{N}(b,w) is represented by a finite set of piecewise bilinear functions Vⁿ={υ [symbol] \dot{π}_{(a,i)}ⁿ [symbol] }_{(a,i)∈I(n)}={ υ̅_{a,i}ⁿ}_{(a,i)∈I(n)} derived (through stages 1,2,3,4,5, Appendix) from functions {υ [symbol] \dot{π}_{i′}ⁿ⁺¹ [symbol] }_{i′∈I(n+1)} which proves the claims of the induction step and the whole proof by induction.

Thus, in the method implemented by the solver, the output produced at each of the equations below is a new (temporary) set of bilinear functions, represented using the corresponding new (temporary) constants c and d (with different indices). At the last step, the solver returns the value function V(b,w) at an epoch n that is represented using sets of bilinear functions Vⁿ={υ [symbol] \dot{π}_{(a,i)}ⁿ [symbol] }_{(a,i)∈I(n)}={ υ̅_{a,i}ⁿ}_{(a,i)∈I(n)}, each function represented using calculated constants cⁿ_{i,k,s} and dⁿ_{i,k,s} for s from S and k from I(n,i) (i.e., an index from a set I(n,i) of indices associated with decision epoch n and point based policy number i. By examining these value functions V(b,w) the agent can then choose an action that (given b and w) is guaranteed to yield the highest expected total reward (as explained earlier) in decision epoch n.

Thus, when the algorithm terminates, each bilinear function “fᵢ” from set Vⁿ={υ [symbol] \dot{π}_{(a,i)}ⁿ [symbol] }_{(a,i)∈I(n)}={ υ̅_{a,i}ⁿ}_{(a,i)∈I(n)} is represented using constants cⁿ_{i,k,s} and dⁿ_{i,k,s} for s from S and k from I(n,i)={set of indices}. That is, each function

f_{i=sum {}s}(b(s)*(cⁿ_{i,k,s}*w+dⁿ_{i,k,s}))

is bilinear.

FIG. 6 graphically depicts, in an example embodiment, the solver results 220 for extracting an agent policy, e.g., an investment action to perform. That is, to find what action an agent should execute in decision epoch n, with wealth w and belief state b (if it believes that current state is “s” with probability b(s), for all s from S), the agent then looks at the value function Vⁿ(b,w). When the solver terminates, as shown in FIG. 6, each value function Vⁿ(b,w) is represented by a set Vⁿ={υ [symbol] \dot{π}_{(a,i)}ⁿ [symbol] }_{(a,i)∈I(n)}={ υ̅_{a,i}ⁿ}_{(a,i)∈I(n)} of bilinear functions 250, and each of these bilinear functions has associated with it the first action “a” that should be executed to yield a corresponding bilinear function given a risk of being within a risk sensitive state, e.g., perceived probability between state s 211 and s1 212. An agent compares the values of all these bilinear functions at argument (b,w) and may choose to execute action “a” that is associated with the dominant bilinear function at argument (b,w). As an example, action “a” could be: invest/do not invest in X/Y/Z etc. in decision epoch n.

That is, in view of FIG. 6, at an example decision epoch n, a point based policy is given for any pair (b,w). The depth of such policy is the number of decision epochs to go. For example, if N=4 decision epochs, then at decision epoch n=2, a point based policy will ascribe actions to decision epochs 3 and 4. When the user occupies pair (b,w) at decision epoch n, it looks at which bilinear function 250 is dominant for this pair (b,w) at decision epoch n and then retrieves point based policy “π” assigned to this dominant bilinear function (each bilinear function has a point-based policy assigned to it). The first action on the retrieved point-based policy is the action that the agent should perform next. Conversely, if this (retrieved) point-based policy were to be executed many times, it would on average yield utility given by the dominant utility function for pair (b,w).

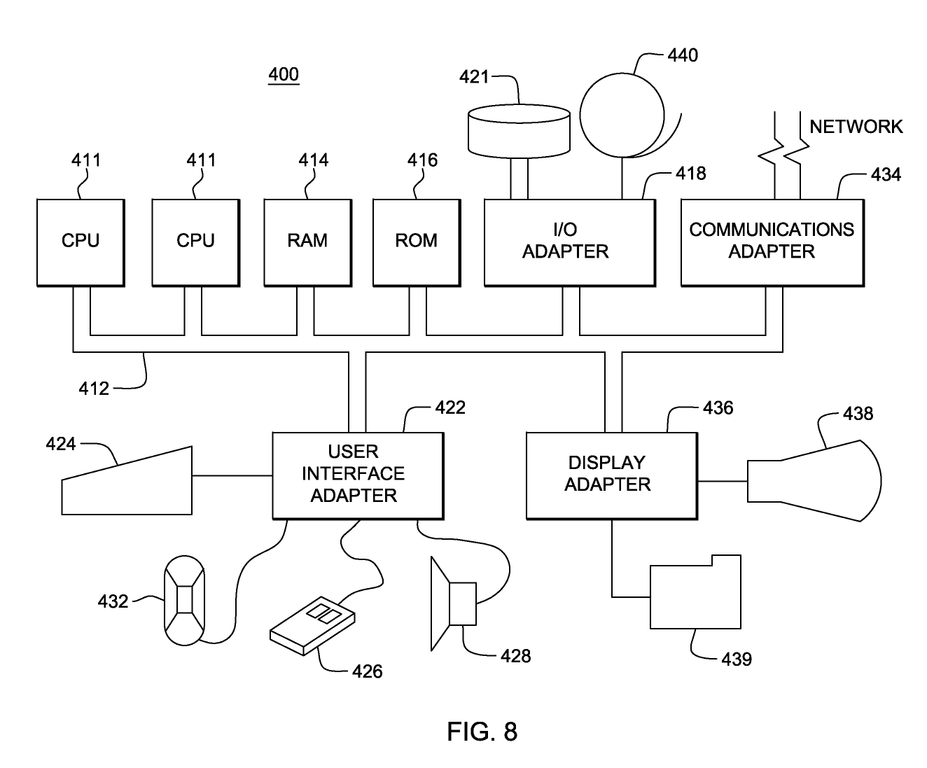

FIG. 8 graphically depicts solver results for example strategies (e.g., two different actions) as two example value functions 275a, 275b to maximize an expected utility based on proposed strategy. More particularly, the two value functions 275A, 275B depicted in FIG. 8 is associated with a point-based policy. To determine which point based policy an agent would follow when in a pair (b,w), it is determined which utility function is dominant at the pair (b,w).

In a further embodiment, in order to speed up the implemented Risk-Sensitive POMDP solver, the system and method includes finding and pruning the dominated investment strategies using efficient linear programming approximations to underlying non-convex bilinear programs. Thus, referring to FIG. 2C, continuing to step 170, there is performed pruning bilinear functions that are completely dominated by other bilinear functions. The determination as to whether a function υ_{a,i}ⁿ is dominated by another, is now explained:

In one exemplary embodiment, as mentioned in the stages 1,3,5 of the induction proof incorporated herein such as described in Appendix, the solver implements functionality for speeding up the algorithm by pruning, from a set of piecewise bilinear functions, these functions that are jointly dominated by other functions. The solver implemented quickly and accurately identifies if a function is dominated or not. Formally, for a set of piecewise bilinear functions V={υᵢ:B×W→R}_{i∈I} there is determined if some υⱼ∈V is dominated, i.e., if for all (b,w)∈B×W there exists υᵢ∈V,i≠j such that υᵢ(b,w)>υⱼ(b,w).

Letting υᵢ∈V be piecewise bilinear over B×W , i.e., there is a partitioning {B×W_{i,k}}_{1≦k≦K(i)} of B×W such that set W_{i,k} is convex and υᵢ(b,w)=Σ_{s∈S}c_{i,k}^{s}w+d_{i,k}^{s} for all (b,w)∈B×W_{i,k}, 1≦k≦K(i). Thus, there exists wealth levels w=w_{i,0}<. . . <w_{i,k}<. . . <w_{i,K(i)}= w̅ such that W_{i,k}=[w_{i,k-1},w_{i,k}] for all 1≦≦k≦K(i) where K(i) is the number of intervals in which the whole wealth interval (Wₘᵢₙ, Wₘₐₓ) is split. In determining whether υⱼ∈V is dominated functions of V are first split into functions defined over common wealth intervals. Precisely, let W={wₖ}_{0≦k≦K}:=∪_{i∈I}{w_{i,k}}_{1≦k≦K(i)} be a set of common wealth levels where w=w₀<. . . <wₖ<. . . w_{K}= w̅. For all (b,w)∈B×[wₖ₋₁,wₖ], 1≦k≦K then υᵢ,(b,w) is represented with υ_{i,k}(b,w):=Σ_{s∈S} c̅_{i,k}^{s}w+ d̅_{i,k}^{s} where c̅_{i,k}^{s}:= c̅_{i,k′}^{s}, d̅_{i,k}^{s}:= d̅_{i,k′}^{s} for k′ such that w∈[w_{i,k′-1},w_{i,k′}], for all i∈I.

υⱼ∈V is then not dominated if there exists 1≦k≦K and (b,w)∈B×[wₖ₋₁,wₖ] such that for all υᵢ∈V, i≠j it holds that υ_{i,k}(b,w)<υ_{j,k}(b,w). That is, if for some 1≦k≦K there exists a feasible solution (b,w) to Program

$$max 0 \vert \begin{matrix}{υ}_{j , k} ( b , w ) - {υ}_{i , k} ( b , w ) > 0 & ∀ {υ}_{i} ∈ V \\ {w}_{k - 1} \leq w \leq {w}_{k} & \\ {\sum }_{s ∈ S} b ( s ) = 1 & \end{matrix} \qquad 16 a )$$

also written as

$$max 0 \vert \begin{matrix}{\sum }_{s ∈ S} b ( s ) ( {c}_{i , j , k}^{s} w + {d}_{i , j , k}^{s} ) > 0 & ∀ {v}_{i} ∈ V \\ {w}_{k - 1} \leq w \leq {w}_{k} & \\ {\sum }_{s ∈ S} b ( s ) = 1 & \end{matrix} \qquad 16 b )$$

where the program “max O”[+terms]” represents the attempt to maximize the objective function “O”, i.e., an empty/blank objective function; variable b=[b(s)]_{s∈S} is a vector; c_{i,j,k}^{s}:= c̅_{j,k}^{s}− c̅_{i,k}^{s} and d_{i,j,k}^{s}:= d̅_{j,k}^{s}− d̅_{i,k}^{s}.

In one embodiment, due to presence of non-linear, non-convex constraints in solving Program (16b), i.e., because of term Σ_{s∈S}b(s)c_{i,j,k}^{s}w+d_{i,j,k}^{s})>0, υᵢ∈V, a solution is to relax the constraints.

However, by relaxing the constraints of Program (16b), the chance of finding a feasible solution (b,w) is increased, thus decreasing the chance of pruning υⱼ from V. Therefore such a relaxation may result in keeping in V some of the dominated functions, which may slow down the algorithm.

As some of the constraints in these Programs (16,17,18) involve a multiplication of variables b and w there is a quadratic term which must be linearized before being input to CPLEX solver. By replacing variables (b,w) with (b′,x), any quadratic terms can be eliminated, and therefore the program can be fed to a linear program solver CPLEX.

By approximating Equation 16 generation with a linear program, this can be fed to a CPLEX solver to indicate whether the corresponding linear program has a feasible solution. Thus, one relaxation approximates Program (16b) with a linear program

$$max 0 \vert \begin{matrix}{\sum }_{s ∈ S} x ( s ) {c}_{i , j , k}^{s} + {b}^{′} ( s ) {d}_{i , j , k}^{s} > 0 & ∀ {υ}_{i} ∈ V \\ {b}^{′} ( s ) {w}_{k - 1} \leq x ( s ) \leq {b}^{′} ( s ) {w}_{k} & ∀ s ∈ S \\ {\sum }_{s ∈ S} {b}^{′} ( s ) = 1 & \end{matrix} \qquad 17 )$$

where b′=[b′(s)]_{s∈S} and x=[x(s)]_{s∈S} are vectors. Program (17) relaxes Program (16b) because for any feasible solution (b,w) there exists a corresponding feasible solution (b′:=b,x:=bw). If Σ_{s∈S}b(s)(c_{i,j,k}^{s}w+d_{i,j,k}^{s})>0 in Program (16b), then Σ_{s∈S}b(s)wc_{i,j,k}^{s}+b(s)d_{i,j,k}^{s}>0 and thus, Σ_{s∈S}x(s)c_{i,j,k}^{s}b′(s)d_{i,j,k}^{s}>0 in Program (17), for all υᵢ∈V. Next, if wₖ₋₁≦w≦wₖ in Program (16b) then for all s∈S, b(s)wₖ₋₁≦b(s)w≦b(s)wₖ and thus b′(s)wₖ₋₁≦x(s)≦b′(s)wₖ in Program (17). Finally, if Σ_{s∈S}b(s)=1 then Σ_{s∈S}b′(s)=1. Conversely, a feasible solution (b′,x) may not imply a corresponding feasible solution (b,w). That is, while Σ_{s∈S}x(s)c_{i,j,k}^{s}+b′(s)d_{i,j,k}^{s}>0 in Program (17) implies that Σ_{s∈S}b′(s)([x(s)/b′(s)]c_{i,j,k}^{s}+d_{i,j,k}^{s}k )>0, all the ratios [x(s)/b′(s)],s∈S would need to be equal to some unique wₖ₋₁≦w≦wₖ for Σ_{s∈S}b′(s)(c_{i,j,k}^{s}w+d_{i,j,k}^{s}k )>0 to hold.

Because Program (17) relaxes Program (16b), its decision to not prune υⱼ from V—a result of finding a feasible solution (b′,x)—in one embodiment, may be too conservative. However, the smaller the wealth interval [wₖ₋₁,wₖ], the more accurate Program (17) becomes, that is, the greater the chance that a feasible solution (b′,x) implies a feasible solution (b,w). Thus, for a given feasible solution (b,x), let (b:=b′,w:=wₖ₋₁) be a candidate solution to Program (16b). Clearly Σ_{s∈S}b(s)=1 and wₖ₋₁≦w≦wₖ. In addition, for all υᵢ∈V it holds for Cᵢ^{max}:=max_{s∈S}|c_{i,j,k}^{s} that

$$\begin{matrix}( {w}_{k} - {w}_{k - 1} ) {C}_{i}^{max} + {\sum }_{s ∈ S} b ( s ) ( {c}_{i , j , k}^{s} w + {d}_{i , j , k}^{s} ) = {\sum }_{s ∈ S} {b}^{′} ( s ) ( {w}_{k} - {w}_{k - 1} ) {C}_{i}^{max} + \\ {\sum }_{s ∈ S} {b}^{′} ( s ) ( {c}_{i , j , k}^{s} w + {d}_{i , j , k}^{s} ) \\ \geq {\sum }_{s ∈ S} ( x ( s ) - {b}^{′} ( s ) {w}_{k - 1} ) {c}_{i , j , k}^{s} + \\ {\sum }_{s ∈ S} {b}^{′} ( s ) ( {c}_{i , j , k}^{s} w + {d}_{i , j , k}^{s} ) \\ = {\sum }_{s ∈ S} x ( s ) {c}_{i , j , k}^{s} - {b}^{′} ( s ) {w}_{k - 1} {c}_{i , j , k}^{s} + \\ {b}^{′} ( s ) {w}_{k - 1} {c}_{i , j , k}^{s} + {b}^{′} ( s ) {d}_{i , j , k}^{s} \\ = {\sum }_{s ∈ S} x ( s ) {c}_{i , j , k}^{s} + {b}^{′} ( s ) {d}_{i , j , k}^{s} > 0\end{matrix}$$

and thus, lim_{w}_{ₖ}_{-w}_{_{k−1}}_{→0}Pr[Σ_{s∈S}b(s)(c_{i,j,k}^{s}w+d_{i,j,k}^{s})>0]=1. Consequently, as wₖ−wₖ₋₁→0, the probability that a feasible solution (b′,x) implies a feasible solution (b,w) approaches 1 and the error of approximating Program (16b) with Program (17) approaches 0.

In one embodiment, to speed up the algorithm, the constraint Σ_{s∈S}x(s)c_{i,j,k}^{s}+b′(s)d_{i,j,k}^{s}>0 of Program (17) is tightened by some ε>0. Specifically, it is less likely to find a feasible solution to Program

$$max 0 \vert \begin{matrix}{\sum }_{s ∈ S} x ( s ) {c}_{i , j , k}^{s} + {b}^{′} ( s ) {d}_{i , j , k}^{s} > ɛ & ∀ {υ}_{i} ∈ V \\ {b}^{′} ( s ) {w}_{k - 1} \leq x ( s ) \leq {b}^{′} ( s ) {w}_{k} & ∀ s ∈ S \\ {\sum }_{s ∈ S} {b}^{′} ( s ) = 1 & \end{matrix} \qquad 18 )$$

than to Program (17) and thus, more likely to prune more functions from V, which speeds up the algorithm. However, Program (18) may classify some of the non-dominated functions as dominated ones and hence, the pruning procedure will no longer be error-free. The total error of the algorithm, however, is bounded. In one embodiment, it can be trivially bounded by ε·3·N, where a tunable parameter ε of Program (18) is the error of the pruning procedure, 3 is the number of stages (of the proof by induction) that call the pruning procedure and N is the planning horizon.

Thus, speeding up the algorithm described by equations 16), 17), 18) as solver finds the value functions Vⁿ(b,w) (for the decision epochs n=0,1, . . . ,N) and each value function is represented by a number of bilinear functions. Some of these bilinear functions might be redundant, because they are completely dominated by other bilinear functions and hence, will never be used by the agent when deciding what action to execute. These completely dominated bilinear functions are pruned while the underlying value functions are still represented exactly, but with a reduced number of bilinear functions. This reduces computation time, because the number of bilinear functions needed (e.g., in a worst case) to represent the value function grows exponentially with n.

This methodology scales to larger extensions. For example, there is considered a bigger domain, including 100 different states of the market (e.g., markets of different countries), and considering 5 different actions to invest in markets of different countries. With respect to the algorithm, different values (0.5,1,1.5,2,2.5 ) of the approximation parameter ε (used in Program (18) were tested). Also, the planning horizon was fixed at N=10 and the algorithm is run for each utility function (A),(B),(C),(D),(E) as shown in the plot of utility functions 300 shown in FIG. 3.

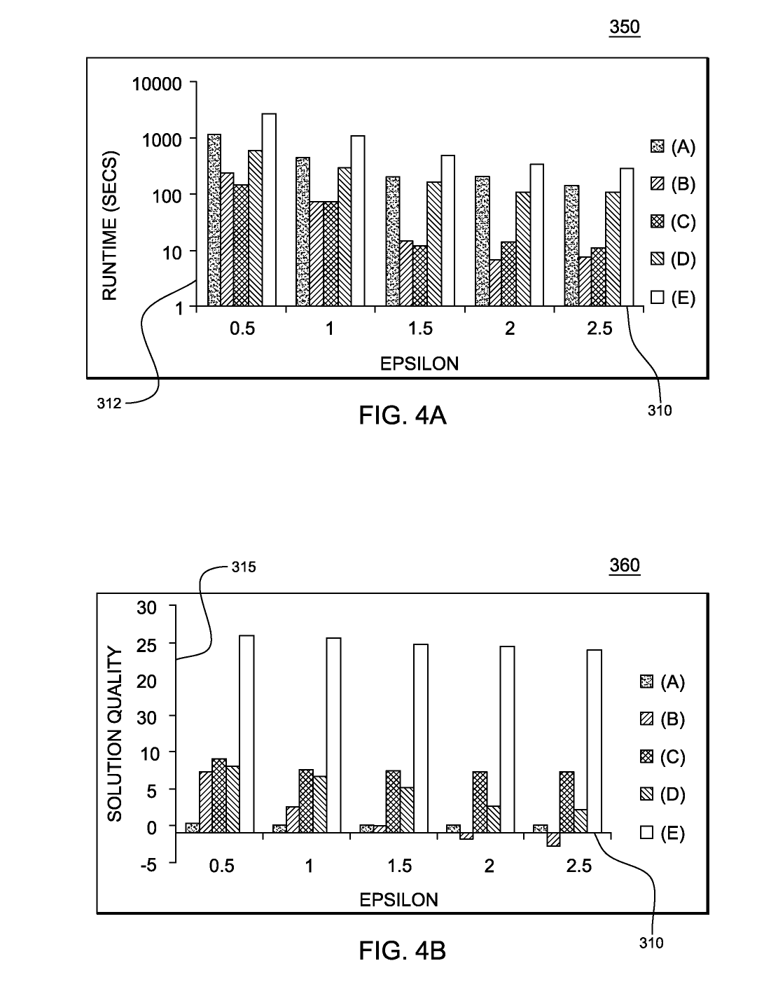

FIG. 4A present results 350 plotting “ε” (epsilon) 310 on the x-axis and the runtime 312 (e.g., in seconds on the logarithmic scale) on the y-axes and FIG. 4B is a plot 360 depicting epsilon 310 vs. the solution quality 315 plotted on the y-axes. As can be seen, as shown in FIG. 4B, irrespective of the utility function (A-E) considered in FIG. 3, the algorithm runtime decreases drastically (with only small increases in ε) while the solution quality remains almost constant. For example, for the utility function (C) depicted in plot 350 shown in FIG. 4A, a change of ε from 0.5 to 1.5 caused the reduction of the algorithm runtime by over one order of magnitude (from 149 s to only 12 s) and only 18% (from 9.08 to 7.38 ) decrease of the solution quality as shown in the plot 360 for the utility function (C) of FIG. 4B.

Thus, by employing Risk-Sensitive POMDPs, an extension of POMDPs, in risk domains such as financial planning, the agents are able to maximize the expected utility of their actions. The exact algorithm solves Risk-Sensitive POMDPs, for piecewise linear utility functions by representing the underlying value functions with sets of piecewise bilinear functions—computed exactly using functional value iteration—and pruning the dominated bilinear functions using efficient linear programming approximations of the underlying non-convex bilinear programs.

FIG. 9 illustrates an exemplary hardware configuration of a computing system 400 running and/or implementing the method steps described herein. The hardware configuration preferably has at least one processor or central processing unit (CPU) 411. The CPUs 411 are interconnected via a system bus 412 to a random access memory (RAM) 414, read-only memory (ROM) 416, input/output (I/O) adapter 418 (for connecting peripheral devices such as disk units 421 and tape drives 440 to the bus 412 ), user interface adapter 422 (for connecting a keyboard 424, mouse 426, speaker 428, microphone 432, and/or other user interface device to the bus 412), a communication adapter 434 for connecting the system 400 to a data processing network, the Internet, an Intranet, a local area network (LAN), etc., and a display adapter 436 for connecting the bus 412 to a display device 438 and/or printer 439 (e.g., a digital printer of the like).

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with a system, apparatus, or device running an instruction.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with a system, apparatus, or device running an instruction. Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may run entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which run via the processor of the computer or other programmable data processing apparatus, create means for implementing the functions/acts specified in the flowchart and/or block diagram block or blocks. These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which run on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more operable instructions for implementing the specified logical function(s). It should also be noted that, in some alternative implementations, the functions noted in the block may occur out of the order noted in the figures. For example, two blocks shown in succession may, in fact, be run substantially concurrently, or the blocks may sometimes be run in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

### APPENDIX

### Induction Base:

Assume n=N. Let Y₀^{N :=B×W}^{N}, I(N):={0} and \dot{π}₀^{N} be an arbitrary policy. Because at decision epoch N the process terminates, it holds for all (b,w)∈Y₀^{N} that (from Equations (2) and (5)) V_{U}^{N}(b,w)=U(w)=E[U(w)]=E[U(w+Σ_{n=N}^{N-1}rₙ)|\dot{π}₀^{N},b₀=b])=υ [symbol] \dot{π}₀^{N} [symbol] (b,w)=max_{i∈I(N)}υ [symbol] \dot{π}ᵢ^{N} [symbol] (b,w), which proves claim 1. Furthermore, to prove that υ [symbol] \dot{π}₀^{N} [symbol] is piecewise bilinear, let I(N,0):={1, . . . ,K} and W_{0,k}^{N}:=[wₖ, wₖ₊₁), k∈I(N,0). Clearly, {B×W_{0,k}^{N}}_{k∈I(N,0)} is a finite partitioning of B×Wⁿ and sets W_{0,k}^{N}:=k∈I(N,0) are convex. In addition, υ [symbol] \dot{π}₀^{N} [symbol] (b,w)=Σₛb(s)(Cₖw+Dₖ)=Cₖw+Dₖ for all (b,w)∈B×W_{0,k}^{N}, k∈I(N,0) and hence, υ [symbol] \dot{π}₀^{N} [symbol] (b,w) is linear—thus also piecewise bilinear—over (b,w)∈B×W ^{N}, which proves claim 2. Finally, claim 3 holds because we constructed υ [symbol] \dot{π}₀^{N} [symbol] without even considering the set of functions {υ [symbol] \dot{π}_{i′}^{N+1} [symbol] }_{i′∈I(N+1)} and our choice of \dot{π}₀^{N} was arbitrary. The induction thus holds for n=N.

### Induction Step:

Assume now that the induction holds for n+1 . Our goal is to prove that it also holds for n. To this end, recall from Equation (3) that V_{U}ⁿ(b,w) is calculated by

$${max}_{a ∈ A} \{ {\sum }_{z ∈ Z} P ( z \vert b , a ) {V}_{U}^{n + 1} ( T ( b , a , z ) , w + R ( b , a ) ) \} .$$

We break this calculation into five stages. First, we calculate V_{U,a,z}ⁿ(b,w):=V_{U}ⁿ⁺¹(T(b,a,z),w) where V_{U}ⁿ⁺¹ is represented by {υ [symbol] \dot{π}ᵢⁿ⁺¹ [symbol] }_{i∈I(n+1)} from the induction assumption. Next, we derive V̅_{U,a,z}ⁿ(b,w):=P(z|b,a)V_{U,a,z}ⁿ(b,w) and then V_{U,a}ⁿ(b,w):=Σ_{z∈Z}(b,w). Finally, we derive V̅_{U,a}ⁿ(b,w):=V_{U,a}ⁿ(b,w+R(b,a)) and conclude the proof of the induction step by deriving V_{U}ⁿ(b,w):=max_{a∈A} V̅_{U,a}ⁿ(b,w) where V_{U}ⁿ is represented by {υ [symbol] \dot{π}ᵢⁿ [symbol] }_{i∈I(n)}.

### Stage 1:

Calculate V_{U,a,z}ⁿ(b,w):=V_{U}ⁿ⁺¹(T(b,a,z),w).

From the induction assumption, V_{U}ⁿ⁺¹ is represented by a finite set of functions {υ [symbol] \dot{π}ᵢⁿ⁺¹ [symbol] }_{i∈I(n+1)}, corresponding to point-based policies \dot{π}ᵢ, i∈I(n+1), and each υ [symbol] \dot{π}ᵢⁿ⁺¹ [symbol] is piecewise bilinear. We now prove that V_{U,a,z}ⁿ(b,w):=V_{U}ⁿ⁺¹(T(b,a,z),w) can be represented by a finite set of functions V_{a,z}ⁿ(b,w):={υ_{a,z,i}ⁿ}_{i∈I(n+1)} derived from a collection of functions {υ [symbol] \dot{π}ᵢⁿ⁺¹ [symbol] }_{i∈I(n+1)} and that each function υ_{a,z,i} ⁿ is piecewise bilinear. To this end, define a finite partitioning {Y_{a,z,i}ⁿ}_{i∈I(n+1)} of B×Wⁿ⁺¹ where

$${Y}_{a , z , i}^{n} := \{ ( b , w ) ∈ B \times {W}^{n + 1} \vert υ 〈 {\dot{π}}_{i}^{n + 1} 〉 ( T ( b , a , z ) , w ) = {max}_{{i}^{′} ∈ I ( n + 1 )} υ 〈 {\dot{π}}_{{i}^{′}}^{n + 1} 〉 ( T ( b , a , z ) , w ) \} \qquad ( 6 )$$

and a finite set of functions V_{a,z}ⁿ={υ_{a,z,i}^{n}}_{i∈I(n+1)} where

υ_{a,z,i}ⁿ(b,w):=υ [symbol] \dot{π}ᵢⁿ⁺¹ [symbol] (T(b,a,z),w) (7)

for all (b,w)∈B×Wⁿ⁺¹ . It is then true that for all (b,w)∈B×Wⁿ⁺¹ there exists i∈I(n+1) such that (b,w)∈Y_{a,z,i}ⁿ and υ_{a,z,i}ⁿ(b,w):=υ [symbol] \dot{π}ᵢⁿ⁺¹ [symbol] (T(b,a,z),w)=max_{i′}υ [symbol] \dot{π}ᵢⁿ⁺¹ [symbol] (T(b,a,z),w)=V_{U,a,z}ⁿ⁺¹(T(b,a,z),w)=V_{U,a,z}ⁿ(b,w). Thus, V_{U,a,z}ⁿ(b,w) can be represented by a finite set of functions V_{a,z}ⁿ={υ_{a,z,i}ⁿ}_{i∈I(n+1)} derived from {υ [symbol] \dot{π}ᵢⁿ⁺¹ [symbol] }_{i∈I (n+1)}. In addition, each υ_{a,z,i}ⁿ is piecewise bilinear as proven by Lemma 1 in the Appendix.

Finally, notice that if function υ_{a,z,i}ⁿ∈V_{a,z}ⁿ is dominated by other functions υ_{a,z,i′}ⁿ∈V_{a,z}ⁿ, i.e., if for any (b,w)∈B×Wⁿ⁺¹ there exists i′∈I(n+1),i′≠i such that υ_{a,z,i}ⁿ(b,w)<υ_{a,z,i′}ⁿ(b,w) then (from definition (6)) Y_{a,z,i}ⁿ=Ø. In such case (to speed up the algorithm) υ_{a,z,i}ⁿ can be pruned from V_{a,z}ⁿ and Y_{a,z,i}ⁿ be removed from {Y_{a,z,i}ⁿ}_{i∈I(n+1)} as that will not affect the representation of V_{U,a,z}ⁿ. (How to determine if a function υ_{a,z,i}ⁿ is dominated is explained later.) The value functions V_{U,a,i}ⁿ(b,w) can thus be represented by a finite sets of piecewise bilinear functions V_{a,z}ⁿ={υ_{a,z,i}ⁿ}_{i∈I(n,a,z)} where I(n,a,z)⊂I(n+1) .

### Stage 2:

Calculate V̅_{U,a,z} ⁿ(b,w):=P(z|b,a)V_{U,a,z}ⁿ(b,w).

Consider the value functions V_{U,a,z}ⁿ(b,w) represented after stage 1 by finite sets of piecewise bilinear functions V_{a,z}ⁿ={υ_{a,z,i}ⁿ}_{i∈I(n,a,z)}. We now demonstrate that the value function V̅_{U,a,z}ⁿ(b,w):=P(z|b,a)V_{U,a,z}ⁿ(b,w) can be represented by a set of piecewise bilinear functions V̅_{a,z}ⁿ={ υ̅_{a,z,i}ⁿ}_{i∈I(n,a,z)} where

υ̅_{a,z,i}ⁿ(b,w):=P(z|b,a)υ_{a,z,i}ⁿ(b,w) (8)

for all (b,w)∈B×Wⁿ⁺¹. Indeed, since {Y_{a,z,i}ⁿ}_{i∈I(n,a,z)} is a partitioning of B×Wⁿ⁺¹ (from definition (6)), it holds for all (b,w)∈B×Wⁿ⁺¹ that there exists i∈I(n,a,z) such that (b,w)∈Y_{a,z,i}ⁿ and V̅_{U,a,z}ⁿ(b,w):=P(z|b,a)V_{U,a,z}ⁿ(b,w)=P(z|b,(b,w)=υ_{a,z,i}ⁿ(b,w) 9̅8̅ _{a,z,i}ⁿ(b,w). Furthermore, each function υ̅_{a,z,i}ⁿ is piecewise bilinear over (b,w)∈B×Wⁿ⁺¹ because for the existing partitioning {B×W_{i,k}ⁿ⁺¹}_{k∈K(n+1,i)} of B×Wⁿ⁺¹ it holds that

$$\begin{matrix}{\overline{υ}}_{a , z , i}^{n} ( b , w ) := P ( z \vert b , a ) {υ}_{a , z , i}^{n} ( b , w ) \\ = P ( z \vert b , a ) {\sum }_{s ∈ S} b ( s ) ( {c}_{a , z , i}^{n , k , s} w + {d}_{a , z , i}^{n , k , s} ) \\ = {\sum }_{s ∈ S} b ( s ) ( {\overline{c}}_{a , z , i}^{n , k , s} w + {\overline{d}}_{a , z , i}^{n , k , s} )\end{matrix} \qquad ( 9 )$$

for all (b,w)∈B×,Wᵢⁿ⁺¹,k∈I(n+1,i) where c̅_{a,z,i}^{n,k,s}=P(z|b,a)c_{a,z,i}^{n,k,s} and d̅_{a,z,i}^{n,k,s}=P(z|b,a)d_{a,z,i}^{n,k,s} are constants.

### Stage 3:

Calculate V_{U,a}ⁿ(b,w):=Σ_{z∈Z} V̅_{U,a,z}ⁿ(b,w).

Consider the value functions V̅_{U,a,z}ⁿ represented after stage 2 by the sets of piecewise bilinear functions V̅_{a,z}ⁿ={ υ̅_{a,z,i}ⁿ}_{i∈I(n,a,z)}. We now show that V_{U,a} ⁿ can be represented with a finite set of piecewise bilinear functions Vₐⁿ={υ_{a,i} ⁿ}_{i∈I(n,a)} derived from the sets of functions V̅_{a,z}ⁿ={ υ̅_{a,z,i}ⁿ}_{i∈I(n,a,z)}z∈Z. To this end, let i:=[i(z)]_{z∈Z}∈I(n,a) denote a vector where i(z)∈I(n,a,z),z∈Z. For each such vector i∈I(n,a) define a set

$${Y}_{a , i}^{n} := {⋂}_{z ∈ Z} {Y}_{a , z , i ( z )}^{n} \qquad ( 10 )$$

and a function

$${υ}_{a , i}^{n} ( b , w ) := {\sum }_{z ∈ Z} {\overline{υ}}_{a , z , i ( z )}^{n} ( b , w ) \qquad ( 11 )$$

for all (b,w)∈B×Wⁿ⁺¹. To show that V_{U,a}ⁿ can be represented with a set of functions Vₐⁿ={υ_{a,i}ⁿ}_{i∈I(n,a)} we first prove that {Y_{a,i}ⁿ}_{i∈(n,a)} is a finite partitioning of B×Wⁿ⁺¹. To this end, first observe that Y_{a,i}ⁿ∩Y_{a,i′}ⁿ=Ø for all i,i′∈I(n,a),i≠i′. Indeed, if i≠i′ then i(z)≠i′(z) for some z∈Z. Thus, if (b,w)∈Y_{a,i}^{n∩Y}_{a,i′}ⁿ then in particular (b,w)∈Y_{a,z,i(z)}ⁿ∩Y_{a,z,i′(z)}ⁿ which is impossible because Y_{a,z,i(z)}ⁿ∩Y_{a,z,i′(z)} ⁿ≠Ø for i(z)≠i′(z) (from definition (6)). Also, if (b,w)∈B×Wⁿ⁺¹ then for all z∈Z there exists some i(z)∈I(n,a,z) such that (b,w)∈Y_{a,z,i(z)}ⁿ (from definition (6)). Hence, for the vector i:=[i(z)]_{z∈Z}∈I(n,a) it must hold that (b,w)∈∩_{z∈Z}Y_{a,z,i(z)}ⁿ=Y_{a,i}ⁿ.

We then show that V_{U,a}ⁿ can be represented with a set of functions Vₐⁿ={υ_{a,i}ⁿ}_{i∈I(n,a)} as follows: Since {Y_{a,i}ⁿ}_{i∈I(n,a)} is a partitioning of B×Wⁿ⁺¹, for each (b,w)∈B×Wⁿ⁺¹ there exists i=[i(z)]_{z∈Z}∈I(n,a) such that (b,w)∈Y_{a,i}ⁿ and V_{U,a}ⁿ(b,w):=Σ_{z∈Z} V̅_{U,a,z}ⁿ(b,w)= υ̅_{a,z,i(z)}ⁿ(b,w)=υ_{a,i}ⁿ(b,w). In addition, each function υ_{a,i}ⁿ(b,w) is piecewise bilinear as proven by Lemma 2 in the Appendix.

Finally, notice that if function υ_{a,i}ⁿ∈Vₐⁿ is dominated by other functions υ_{a,i′}ⁿ∈Vₐⁿ then Y_{a,i}ⁿ=Ø. Precisely, for any (b,w)∈B×Wⁿ⁺¹, if there exists some other function υ_{a,i′}ⁿ∈Vₐⁿ such that υ_{a,i}ⁿ(b,w)<υ_{a,i′}ⁿ(b,w) then (from definition 11) υ̅_{a,z,i(z)}ⁿ(b,w)< υ̅_{a,z,i′(z)}(b,w) for some z∈Z and obviously (from definition (9)) υ_{a,z,i(z)}(b,w)<υ_{a,z,i′(z)}(b,w) which implies that (from definition (6)) (b,w)∉Y_{a,z,i(z)} and obviously (from definition (10)), (b,w)∉Y_{a,i}ⁿ. Therefore (to speed up the algorithm), if function υ_{a,i}ⁿ∈Vₐⁿ is dominated by other functions υ_{a,i′}ⁿ∈Vₐⁿ then υ_{a,i}ⁿ can be pruned from Vₐⁿ and set Y_{a,i}ⁿ be removed from {Y_{a,i}ⁿ}_{i∈I(n,a)} as that will not affect the representation of V_{U,a}ⁿ.

### Stage 4:

Calculate V̅_{U,a}ⁿ(b,w):=V_{U,a}ⁿ(b,w+R(b,a)).

For notational convenience in this stage (but without the loss of precision), we denote vectors i,k defined in stage 3, as i,k. Recall that Wⁿ is the set of all possible wealth levels at decision epoch n and that Wⁿ⁻¹=[wⁿ⁻¹,wⁿ⁻¹]⊂,[wⁿ, w̅ⁿ]=Wⁿ where wⁿ=wⁿ⁻¹+min_{s∈S,a∈A}R(s,a) and w̅ⁿ= w̅ⁿ⁻¹+max_{s∈S,a∈A}R(s,a), for all 1≦n≦N. Hence, we only have to calculate the values V̅_{U,a}ⁿ(b,w), (b,w)∈B×Wⁿ, from the values V_{U,a}ⁿ(b,w+R(b,a)), (b,w)∈B×Wⁿ⁺¹. To this end, we show how to represent V̅_{U,a}ⁿ(b,w), (b,w)∈B×Wⁿ with a finite set of piecewise bilinear functions V̅ₐⁿ={ υ̅_{a,i}ⁿ: B×Wⁿ→R}_{i∈I(n,a)} derived from the set of piecewise bilinear functions Vₐⁿ={υ_{a,i}ⁿ:B×Wⁿ⁺¹→R}_{i∈I(n,a)} from stage 3. Formally, for each i∈I(n,a) define a set

Y̅_{a,i}ⁿ:={(b,w)∈B×Wⁿ

such that

(b,w+R(b,a))∈Y_{a,i}^{n}} (12)

and a function

υ̅_{a,i}ⁿ(b,w):=υ_{a,i}ⁿ(b,w+R(b,a)). (13)

To show that V̅_{U,a}ⁿ can be represented by { V̅ₐⁿ={ υ̅_{a,i}ⁿ }_{i∈I(n,a)} we first need to prove that { Y̅_{a,i}ⁿ}_{i∈I(n,a)} is a finite partitioning of B×Wⁿ. Indeed, if (b,w)∈ Y̅_{a,i}ⁿ∩ Y̅_{a,j}ⁿ for some i,j∈I(n,a) then (b,w+R(b,a))∈Y_{a,i}ⁿ∩Y_{a,j}ⁿ and thus i=j because {Y_{a,i}ⁿ}_{i∈I(n,a)} is a partitioning of B×Wⁿ⁺¹ (from stage 3). In addition, for any (b,w)∈B×Wⁿ we have that (b,w+R(b,a))∈B×Wⁿ⁺¹ (because min_{s∈S,a∈A}R(s,a)≦R(b,a)≦max_{s∈S,a∈A}R(s,a) and thus, (b,w+R(b,a))∈Y_{a,i}ⁿ for some i∈I(n,a), which implies (from definition (12)) that (b,w)∈ Y̅_{a,i}ⁿ.

We then show that V̅_{U,a}ⁿ(b,w) can be represented for all (b,w)∈B×Wⁿ with the set of functions V̅_{a,i}ⁿ={ υ̅_{a,i}ⁿ}_{i∈I(n,a)} as follows: Since { Y̅_{a,i}ⁿ}_{i∈I(n,a)} is a finite partitioning of B×Wⁿ, for all (b,w)∈B×Wⁿ there exists i∈I(n,a) such that (b,w)∈ B̅_{a,i}ⁿ× W̅_{a,i}ⁿ and V̅_{U,a}ⁿ(b,w):=V_{U,a}ⁿ(b,w +R(b,a))=υ_{a,i}ⁿ(b,w+R(b,a))= υ̅_{a,i}ⁿ(b,w). In addition, each function υ̅_{a,i}ⁿ(b,w)∈ V̅ₐⁿ is piecewise bilinear over (b,w)∈B×Wⁿ and can be derived from υ_{a,i}ⁿ∈Vₐⁿ, as shown in Lemma (3) in the Appendix.

### Stage 5:

Calculate V_{U}(b,w):=max_{a∈A} V̅_{U,a}ⁿ(b,w).

Consider the value functions V̅_{U,a}ⁿ represented after stage 4 by the set of piecewise bilinear functions V̅ₐⁿ={ υ̅_{a,i}ⁿ}_{i∈I(n,a)}. To conclude the proof of the induction step, we show how to represent V_{U}ⁿ with a finite set of piecewise bilinear functions Vⁿ={υ [symbol] \dot{π}_{(a,i)}ⁿ [symbol] }_{(a,i)∈I(n)} derived from functions from sets V̅ₐⁿa∈A. To this end, let I(n):={(a,i)|a∈A,i=[i(z)]_{z∈Z}∈I(n,a)}. For each pair (a,i)∈I(n) then define a set

$${Y}_{( a , 1 )}^{n} := \{ ( b , w ) ∈ B \times {W}^{n} \vert {\overline{v}}_{a , 1}^{n} ( b , w ) = {max}_{( {a}^{′} , {i}^{′} ) ∈ I ( n )} {\overline{υ}}_{{a}^{′} , {i}^{′}}^{n} ( b , w ) \} \qquad ( 14 )$$

and a point based policy \dot{π}_{(a,i)}ⁿ according to which the agent first executes action a∈A and then, depending on the observation z∈Z received, follows the policy \dot{π}_{i(z)}ⁿ⁺¹ given by the induction assumption.

Clearly, {Y_{(a,i)}ⁿ}_{(a,z)∈I(n)} is a finite partitioning of B×Wⁿ. Thus, for all (b,w)∈B×Wⁿ there exists some (a,i)∈I(n) such that (b,w)∈Y_{(a,i)}ⁿ and

$${V}_{U}^{n} ( b , w ) := {max}_{( a , i ) ∈ I ( n )} {\overline{υ}}_{a , i}^{n} ( b , w ) ≡ v 〈 {\dot{π}}_{( a , i )}^{n} 〉 ( b , w ) \qquad ( 15 )$$

(the last equality follows directly from definitions (13) (11) (8) (7)). Therefore, V_{U}ⁿ can indeed be represented by a finite set of piecewise bilinear functions Vⁿ={υ [symbol] \dot{π}_{(a,i)}ⁿ [symbol] }_{(a,i)∈I(n)}={ υ̅_{a,i}ⁿ}_{(a,i)∈I(n)} derived (through stages 1,2,3,4,5) from functions {υ [symbol] \dot{π}_{i′}ⁿ⁺¹ [symbol] }_{i′∈I(n+1)}, which proves claims 1, 2 and 3 of the induction step and the whole proof by induction.

Finally, notice that if a function υ [symbol] \dot{π}_{(a,i)}ⁿ [symbol] ∈Vⁿ is dominated by other functions υ [symbol] \dot{π}_{(a′,i′)}ⁿ [symbol] ∈Vⁿ, i.e., if for all (b,w)∈B×Wⁿ there exists some υ [symbol] \dot{υ}_{(a′,i′)}ⁿ [symbol] ∈Vⁿ such that υ [symbol] \dot{π}_{(a,i)}ⁿ [symbol] (b,w)<υ [symbol] \dot{π}_{(a′,i′)}ⁿ [symbol] (b,w) then Y_{(a,i)}ⁿ=Ø. In such case, (to speed up the algorithm) υ [symbol] \dot{υ}_{(a,i)}ⁿ [symbol] can be pruned from Vⁿ and Y_{(a,i)}ⁿ be removed from {Y_{,(a,i)}ⁿ}_{(a,i)∈I(n)} as that will not affect the representation of V_{U}ⁿ.

### Lemma 1

Function υ_{a,z,i}ⁿ:=υ [symbol] \dot{π}ᵢⁿ⁺¹ [symbol] (T(b,a,z),w) is piecewise bilinear over (b,w)∈B×Wⁿ⁺¹.

### Proof.

From induction assumption, υ [symbol] \dot{π}ᵢⁿ⁺¹ [symbol] (b,w) is piecewise bilinear over (b,w)∈B×Wⁿ⁺¹, i.e., there exists a finite partitioning {B×W_{i,k}ⁿ⁺¹}_{k∈I(n +1,i)} of B×Wⁿ⁺¹ such that W_{i,k}ⁿ⁺¹ is a convex set and υ [symbol] \dot{π}ᵢⁿ⁺¹ [symbol] (b,w)=Σ_{s∈S}b(s)(c_{i,k,s}ⁿ⁺¹w+d_{i,k,s}ⁿ⁺¹) for all (b, w)∈B×W_{i,k}ⁿ⁺¹,k∈I(n+1,i). We now prove that υ_{a,z,i}ⁿ(b,w):=υ [symbol] \dot{π}ᵢⁿ⁺¹ [symbol] (T(b,a,z),w) too is piecewise bilinear over (b,w)∈B×Wⁿ⁺¹ for the partitioning {B×W_{i,k}ⁿ⁺¹}_{k∈I(n+1,i)} of B×Wⁿ⁺¹. To this end, for each s∈S distinguish a belief state bₛ∈B such that bₛ(s)=1. It then holds for all (b,w)∈B×Wᵢⁿ⁺¹,k∈I(n+1,i) that

$$\begin{matrix}{υ}_{a , z , i}^{n} ( b , w ) := υ 〈 {\dot{π}}_{i}^{n + 1} 〉 ( T ( b , a , z ) , w ) \\ = {\sum }_{{s}^{′} ∈ S} [ T ( b , a , z ) ( {s}^{′} ) ] ( {c}_{i , k , {s}^{′}}^{n + 1} w + {d}_{i , k , {s}^{′}}^{n + 1} ) \\ = {\sum }_{{s}^{′} ∈ S} {\sum }_{s ∈ S} b ( s ) [ ( {b}_{s} , a , z ) ( {s}^{′} ) ] ( {c}_{i , k , {s}^{′}}^{n + 1} w + {d}_{i , k , {s}^{′}}^{n + 1} ) \\ = {\sum }_{s ∈ S} b ( s ) {\sum }_{{s}^{′} ∈ S} P ( {s}^{′} \vert s , a ) O ( z \vert a , {s}^{′} ) ( {c}_{i , k , {s}^{′}}^{n + 1} w + {d}_{i , k , {s}^{′}}^{n + 1} ) \\ = {\sum }_{s ∈ S} b ( s ) ( {c}_{a , z , i}^{n , k , s} w + {d}_{a , z , i}^{n , k , s} )\end{matrix} \qquad ( 19 )$$

for constants c_{a,z,i}^{n,k,s}Σ_{s′∈S}P(s′|s,a)O(z|a,s′)c_{i,k,s′}ⁿ⁺¹ and d_{a,z,i}^{n,k,s}Σ_{s′∈S}P(s′|s,a)O(z|a,s′)d_{i,k,s′}ⁿ⁺¹. Consequently, function υ_{a,z,i}ⁿ(b,w) is piecewise bilinear over (b,w)∈B×Wⁿ⁺¹ which proves the Lemma.

### Lemma 2

Function υ_{a,i}ⁿ(b,w):=Σ_{z∈Z} υ̅_{a,z,i(z)}ⁿ(b,w) is piecewise bilinear over (b,w)∈B×Wⁿ⁺¹.

### Proof.

After stage 2 it holds for all z∈Z that υ̅_{a,z,i(z)}ⁿ(b,w) is piecewise bilinear over (b,w)∈B×Wⁿ⁺¹, i.e., there exist a partitioning {B×W_{i(z),k} ⁿ⁺¹}_{k␣I(n+1,i(z))} of B×Wⁿ⁺¹ such that W_{i(z),k}ⁿ⁺¹ is a convex set and υ̅_{a,z,i(z)}ⁿ(b,w)=Σ_{s∈S}b(s)( c̅_{a,z,i(z)}^{n,k,s}w+ d̅_{a,z,i(z)}^{n,k,s})for all (b,w)∈B×W_{i(z),k}ⁿ⁺¹k∈I(n+1,i(z)). To prove that υ_{a,i}ⁿ(b,w):=Σ_{z∈Z} υ̅_{a,z,i(z)}ⁿ(b,w) too is piecewise bilinear over (b,w)∈B×Wⁿ⁺¹ we represent υ_{a,i}ⁿ with the set of bilinear functions {υ_{a,i,k}ⁿ}_{k∈I(n,a,i). Precisely, let k:=[k(z)]}_{z∈Z}∈I(n,a,i) denote a vector where k(z)∈I(n+1,i(z)). For each vector k∈I(n,a,i) we define a set

$${W}_{a , i , k}^{n + 1} := {⋂}_{z ∈ Z} {W}_{i ( z ) , k ( z )}^{n + 1} \qquad ( 20 )$$

and a bilinear function

$${υ}_{a , i , k}^{n} ( b , w ) := {\sum }_{s ∈ S} b ( s ) ( {c}_{a , i}^{n , k , s} w + {d}_{a , i}^{n , k , s} ) \qquad ( 21 )$$

for all (b,w)∈B×Wⁿ⁺¹ and constants c_{a,i}^{n,k,s}:=Σ_{z∈Z} c̅_{a,z,i(z)}^{n,k(z),s}, d_{a,i}^{n,k,s}:=Σ_{z∈Z} d̅_{a,z,i(z)}^{n,k(z),s}. To show that υ_{a,i}ⁿ(b,w) can be represented by {υ_{a,i,k}ⁿ(b,w)}_{k∈I(n,a,i)} over all (b,w)∈B×Wⁿ⁺¹ we first prove that {B×W_{a,i,k}ⁿ⁺¹}_{k∈I(n,a,i)} is a finite partitioning of B×Wⁿ⁺¹. To this end, first observe that W_{a,i,k} ⁿ⁺¹∩W_{a,i,k′}ⁿ⁺¹=Ø for any k,k′∈I(n,a,i),k≠k′. Indeed, if k≠k′ then k(z)≠k′(z) for some z∈Z. Hence, if w∈W_{a,i,k}ⁿ⁺¹∩W_{a,i,k′}ⁿ⁺¹ then in particular w∈W_{i(z),k(z)}ⁿ⁺¹∩W_{i(z),k′(z)}ⁿ⁺¹ which is cannot be true as W_{i(z),k(z)}ⁿ⁺¹∩W_{i(z),k′(z)}ⁿ⁺¹=Ø for k(z)≠k′(z) (from claim 2 of the induction assumption). Also, observe that for any w∈Wⁿ⁺¹ there must exist k∈I(n,a,i) such that w∈W_{a,i,k}ⁿ⁺¹, because for all z∈Z, there exists k(z)∈I(n+1,i(z)) such that w∈W_{i(z),k(z)}ⁿ⁺¹ (since {W_{i(z),k(z)}}_{k(z)∈(n+1,i (z))} is a partitioning of Wⁿ⁺¹, from claim 2 of the induction assumption). Thus, vector k:=[k(z)]_{z∈Z}∈I(n,a,i) such that w∈∩_{z∈Z}W_{a,i(z),k(z)}ⁿ⁺¹=W_{a,i,k}ⁿ⁺¹ truly exists. Consequently, {W_{a,i,k}ⁿ⁺¹}_{k∈I(n,a,i)} is a finite partitioning of Wⁿ⁺¹ and {B×W_{a,i,k}ⁿ⁺¹}_{k∈I(n,a,i)} a finite partitioning of B×Wⁿ⁺¹.

We can therefore prove that functions {υ_{a,i,k}ⁿ}_{k∈I(n,a,i)} represent υ_{a,i}ⁿ(b,w) over all (b,w)∈B×Wⁿ⁺¹ as follows: For each (b,w)∈B×Wⁿ⁺¹ there exists k∈I(n,a,i) such that (b,w)∈B×W_{a,i,k}ⁿ⁺¹. Hence, (from definition (20)) (b,w)∈B×W_{i(z),k(z)}ⁿ⁺¹ and thus, (from definition (9)) υ̅_{a,z,i}ⁿ(b,w)=Σ_{s∈S}b(s)( c̅_{a,z,i(z)}ⁿ⁺¹w+ d̅_{a,z,i(z))}ⁿ⁺¹. We can then easily prove that υ_{a,i}ⁿ(b,w):=Σ_{z∈Z} υ̅_{a,z,i(z)}ⁿ(b,w)=Σ_{z∈Z}Σ_{s∈S}b(s)( c̅_{a,z,i(z)}^{n,k(z),s}w+ d̅_{a,z,i(z)}^{n,k(z),s})=Σ_{s∈S}(c_{a,i}^{n,k,s}w+d_{a,i}^{n,k,s})=υ_{a,i,k} ⁿ(b,w). Finally, each set W_{a,i,k}ⁿ⁺¹ is convex because (from definition (20)) it is an intersection of convex sets W_{i(z),k(z)}ⁿ⁺¹, z∈Z.

### Lemma 3

Function υ̅_{a,i}ⁿ(b,w):=υ_{a,i}ⁿ(b,w+R(b,a)) is piecewise bilinear over (b,w)∈B×Wⁿ.

### Proof.

After stage 3 it is true for all i∈I(n,a) that υ_{a,i}ⁿ(b,w) is piecewise bilinear over (b,w)∈B×Wⁿ⁺¹, i.e., there exist a partitioning {B×W_{a,i,k}ⁿ⁺¹}_{k∈I(n,a,i)} of B×Wⁿ⁺¹ such that W_{a,i,k}ⁿ⁺¹ is convex and υ_{a,i}ⁿ(b,w)=υa,i,kⁿ(b,w)=Σ_{s∈S}b(s)(c_{a,i}^{n,k,s}w+d_{a,i}^{n,k,s}) for all (b,w)∈B×W_{a,i,k}ⁿ⁺¹, for all k∈I(n,a,i). To prove that υ̅_{a,i}ⁿ(b,w):=υ_{a,i}ⁿ(b,w+R(b,a)) is piecewise bilinear over (b,w)∈B×Wⁿ we represent υ̅_{a,i}ⁿ with a set of bilinear functions { υ̅_{a,i,k}ⁿ}_{k∈Ī(n,a,i)}. To this end, first, for each k∈I(n,a,i),s∈S define a set

W̅_{a,i,k}^{n,s}:={w∈Wⁿ|w+R(s,a)∈W_{a,i,k}ⁿ⁺¹} (22)

Now, let k:=[k(s)]_{s∈S} denote a vector where k(s)∈I(n,a,i). Ī(n,a,i) is a set of all such vectors k. For each vector k∈(n,a,i) then define a set

$${\overline{W}}_{a , i , k}^{n} := {⋂}_{s ∈ S} {\overline{W}}_{a , i , k ( s )}^{n , s} \qquad ( 23 )$$

and a bilinear function

$${\overline{υ}}_{a , i , k}^{n} ( b , w ) := {\sum }_{s ∈ S} b ( s ) ( {\overline{c}}_{a , i}^{n , k ( s ) , s} w + {\overline{d}}_{a , i}^{n , k ( s ) , s} ) \qquad ( 24 )$$

for all (b,w)∈B×Wⁿ where c̅_{a,i}^{n,k(s),s}:=c_{a,i}^{n,k(s),s} and d̅_{a,i}^{n,k(s),s}:=d_{a,i}^{n,k(s),s}+c_{a,i}^{n,k(s),s}R(s,a) are constants. To show that υ̅_{a,i}ⁿ can be represented by { υ̅_{a,i,k}ⁿ}_{k∈Ī(n,a,i)} we first prove that { W̅_{a,i,k}ⁿ}_{k∈Ī(n,a,i)} is a finite partitioning of Wⁿ. Indeed, for any k,k′∈Ī(n,a,i) if w∈ W̅_{a,i,k}ⁿ∩ W̅_{a,i,k′}ⁿ then (from definition (23)) for all s∈S, w∈ W̅_{a,i,k(s)}^{n,s}∩ W̅_{a,i,k′(s)}^{n,s} and thus (from definition (22)) w+R(s,a)∈W_{a,i,k(s)}ⁿ⁺¹∩W_{a,i,k′(s)}ⁿ⁺¹ for all s∈S, which can only hold if k=k′ (because {W_{a,i,k(s)}ⁿ⁺¹}_{k(s)∈I(n,a,i)} is a partitioning of Wⁿ⁺¹). In addition, for any w∈Wⁿ,s∈S it holds that w+R(s,a)∈Wⁿ⁺¹ and thus, there must exists some k(s)∈I(n,a,i) such that w+R(s,a)∈W_{a,i,k(s)}ⁿ⁺¹. Therefore (from definition (22)) w∈ W̅_{a,i,k(s)}ⁿ for all s∈S and thus (from definition (23)) w∈ W̅_{a,i,k}ⁿ. We have therefore proven that { W̅_{a,i,k}ⁿ}_{k∈Ī(n,a,i)} is a finite partitioning of Wⁿ and that {B× W̅_{a,i,k}ⁿ}_{k∈Ī(n,a,i)} is a finite partitioning of B×Wⁿ.

We then show that functions { υ̅_{a,i,k}ⁿ}_{k∈Ī(n,a,i)} represent υ̅_{a,i}ⁿ(b,w) over all (b,w)∈B×Wⁿ as follows: For each (b,w)∈B×Wⁿ there must exist k∈Ī(n,a,i) such that (b,w)∈B× W̅_{a,i,k}ⁿ and (b,w+R(s,a))∈B× W̅_{a,i,k(s)}ⁿ⁺¹∀s∈S, for which it holds that¹ ¹Recall that for each s∈S we distinguish bₛ∈B such that b ₛ(s)=1.

$$\begin{matrix}{\overline{υ}}_{a ,}^{n} ( b , w ) := {υ}_{a , i}^{n} ( b , w + R ( b , a ) ) \\ = {\sum }_{s ∈ S} b ( s ) {υ}_{a , i}^{n} ( {b}_{s} , w + R ( {b}_{s} , a ) ) \\ = {\sum }_{s ∈ S} b ( s ) {\sum }_{{s}^{′} ∈ S} {b}_{s} ( {s}^{′} ) ( {c}_{a , i}^{n , k ( s ) , {s}^{′}} ( w + R ( s , a ) ) + {d}_{a , i}^{n , k ( s ) , {s}^{′}} ) \\ = {\sum }_{s ∈ S} b ( s ) ( {c}_{a , i}^{n , k ( s ) , s} w + {c}_{a , i}^{n , k ( s ) , s} R ( s , a ) + {d}_{a , i}^{n , k ( s ) , s} ) \\ = {\sum }_{s ∈ S} b ( s ) ( {\overline{c}}_{a , i}^{n , k ( s ) , s} w + {\overline{d}}_{a , i}^{n , k ( s ) , s} ) \\ = {\overline{υ}}_{a , i , k}^{n} ( b , w )\end{matrix} \qquad ( 25 )$$

Finally, each set W̅_{a,i,k}ⁿ is convex because it is an intersection of convex sets W̅_{a,i,k(s)}^{n,s}, s∈S (translation of a convex set W_{a,i,k(s)}ⁿ⁺¹ by a vector R(s,a) results in a convex set).

Having thus described our invention, what we claim as new, and desire to secure by Letters Patent is:

1. A method for determining an investment strategy for a risk-sensitive user comprising:
modeling an user's attitude towards risk as one or more utility functions, said utility functions, said utility function transforming a wealth of said user into a utility value;
generating a risk-sensitive Partially Observable-Markov Decision Process (PO-MDP) based on said one or more utility functions; and,
implementing Functional Value Iteration for solving said risk sensitive PO-MDP,
said solution determining an action or policy calculated to maximize an expected total utility of an agent's actions at a particular point in time acting in a partially observable environment.

2. The method as in claim 1, wherein said generating said risk-sensitive PO-MDP comprises:
generating an expected utility function V_{U}ⁿ(b,w) for 0≦n≦N, b∈B, w∈Wⁿ where Wⁿ denotes the set of all possible user wealth levels in decision epoch n; and,
maximizing said expected utility function V_{U}ⁿ(b,w) for a user when commencing action a∈A, where A is a set of Actions, in decision period n in a belief state b with a wealth level w.

3. The method as in claim 2, further comprising:
receiving incomplete information about a current state s∈S of the process; and,
representing a belief state b as a current probability distribution b(s) over states s∈S.

4. The method as in claim 3, wherein said expected utility function V_{U}ⁿ(b,w) for executing action a is governed according to:
$${max}_{a ∈ A} \{ {\sum }_{z ∈ Z} P ( z \vert b , a ) {V}_{U}^{n + 1} ( T ( b , a , z ) , w + R ( b , a ) ) \}$$
for all b∈B and w∈Wⁿ and, for all 0≦n≦N, where V_{U}ⁿ⁺¹ is a value function calculated for period n+1; wherein,
P(z|b,a)=Σ_{s′∈S}O(z|a,s′)Σ_{s∈S}P(s′|s,a)b(s) represents a probability of observing z after executing action a from belief state b, where s is a starting state and s′ is a destination state;
R(b,a) :=Σ_{s∈S}b(s)R(s,a) is an expected immediate reward that the user receives for executing action a in belief state b; and
T(b,a,z) is the new belief state of the agent after executing action a from belief state b and observed z.

5. The method as in claim 4, further comprising:
iteratively constructing a finite partitioning of a B×W search space into regions where said value functions are represented with point based policies; and
determining from said regions an action.

6. The method as in claim 5, further comprising, at each iteration:
representing V_{U}ⁿ⁺¹(b,w) using a finite set of bilinear functions γⁿ⁺¹; and,
constructing, from said set of bilinear functions from γⁿ⁺¹, a set of bilinear functions γⁿ that jointly represent V_{U} ⁿ(b,w), wherein at an end of each said iteration,
determining from said set of bilinear functions γⁿ what action a∈A said user should execute in decision epoch n∈[0, 1, . . . , N], with wealth level w∈[wₘᵢₙ, wₘₐₓ], given an inventor belief state b(s), for all s∈S.

7. The method as in claim 6, further comprising:
determining whether a bilinear function of said bilinear functions is jointly dominated by other functions; and,
pruning from γⁿ those bilinear functions that are completely dominated by other bilinear functions.

8. The method as in claim 7, wherein said determining whether a function is jointly dominated comprises:
splitting said functions of into functions defined over common wealth interval wₖ₋₁≦w≦wₖ; and,
determining if a feasible solution (b,w) exists for 1≦k≦K according to a first program having quadratic terms; and,
linearizing said first program to obtain a second program having linear teens.

9. The method as in claim 8, wherein said first program is governed according to:
$$max 0 \vert \begin{matrix}{\sum }_{s ∈ S} b ( s ) ( {c}_{i , j , k}^{s} w + {d}_{i , j , k}^{s} ) > 0 & ∀ {υ}_{i} ∈ V \\ {w}_{k - 1} \leq w \leq {w}_{k} & \\ {\sum }_{s ∈ S} b ( s ) = 1 & \end{matrix}$$
where Σ_{s∈S}b(s)(c_{i,j,k}^{s}w+d_{i,j,k}^{s})>0, υᵢ∈V, is a constraint; and, said second program is governed according to:
$$max 0 \vert \begin{matrix}{\sum }_{s ∈ S} x ( s ) {c}_{i , j , k}^{s} + {b}^{′} ( s ) {d}_{i , j , k}^{s} > 0 & ∀ {υ}_{i} ∈ V \\ {b}^{′} ( s ) {w}_{k - 1} \leq x ( s ) \leq {b}^{′} ( s ) {w}_{k} & ∀ s ∈ S \\ {\sum }_{s ∈ S} {b}^{′} ( s ) = 1 & \end{matrix}$$
where b′ and x are vectors such that, for any feasible solution (b,w), there exists a corresponding feasible solution (b′:=b,x:=bw) , wherein by decreasing a wealth interval, wₖ−Wₖ₋₁→0, a probability that a feasible solution (b′,x) implies a feasible solution (b,w) approaches 1 and an error of linearizing approaches 0.

10. The method as in claim 9, further comprising;
tightening a constraint Σ_{s∈S}x(s)c_{i,j,k}^{s}+b′(s)d_{i,j,k}^{s}>0 by a value ε∈>0 wherein said second program is governed according to:
$$max 0 \vert \begin{matrix}{\sum }_{s ∈ S} x ( s ) {c}_{i , j , k}^{s} + {b}^{′} ( s ) {d}_{i , j , k}^{s} > ɛ & ∀ {υ}_{i} ∈ V \\ {b}^{′} ( s ) {w}_{k - 1} \leq x ( s ) \leq {b}^{′} ( s ) {w}_{k} & ∀ s ∈ S \\ {\sum }_{s ∈ S} {b}^{′} ( s ) = 1 & \end{matrix}$$
resulting in pruning of more functions from V and decreasing method execution time.

11. A system for determining an investment strategy for a risk-sensitive user comprising:
a memory;
a processor in communications with the memory, wherein the system performs a method comprising:
modeling an user's attitude towards risk as one or more utility functions, said utility functions said utility function transforming a wealth of said user into a utility value;
generating a risk-sensitive Partially Observable-Markov Decision Process (PO-MDP) based on said one or more utility functions; and,
implementing Functional Value Iteration for solving said risk sensitive PO-MDP,
said solution determining an action or policy calculated to maximize an expected total utility of an agent's actions at a particular point in time acting in a partially observable environment.

12. The system as in claim 11, wherein said generating said risk-sensitive PO-MDP comprises:
generating an expected utility function V_{U} ⁿ(b,w) for 0≦n≦N, b∈B, w∈Wⁿ where Wⁿ denotes the set of all possible user wealth levels in decision epoch n; and,
maximizing said expected utility function V_{U}ⁿ(b,w) for a user when commencing action a∈A, where A is a set of Actions, in decision period n in a belief state b with a wealth level w.

13. The system as in claim 12, further comprising:
receiving incomplete information about a current state s∈S of the process; and,
representing a belief state b as a current probability distribution b(s) over states s∈S.

14. The system as in claim 13, wherein said expected utility function V_{U}ⁿ(b,w) for executing action a is governed according to:
$${max}_{a ∈ A} \{ {\sum }_{z ∈ Z} P ( z \vert b , a ) {V}_{U}^{n + 1} ( T ( b , a , z ) , w + R ( b , a ) ) \}$$
for all b∈B and w∈Wⁿ and, for all 0≦n≦N, where V_{U}ⁿ is a value function calculated for period n+1; wherein,
P(z|b,a)=Σ_{s∈S}O(z|a,s′)Σ_{s∈S}P(s′|s,a)b(s) represents a probability of observing z after executing action a from belief state b, where s is a starting state and s′ is a destination state;
R(b,a):=Σ_{s∈S}b(s)R(s,a) is an expected immediate reward that the user receives for executing action a in belief state b; and
T(b,a,z) is the new belief state of the agent after executing action a from belief state b and observed z.

15. The system as in claim 14, wherein said system further performs:
iteratively constructing a finite partitioning of a B×W search space into regions where said value functions are represented with point based policies; and
determining from said regions an action.

16. The system as in claim 15, further comprising, at each iteration of said Functional Value Iteration:
representing V_{U}ⁿ⁺¹(b,w) using a finite set of bilinear functions γⁿ⁺¹; and,
constructing, from said set of bilinear functions from γⁿ⁺¹, a set of bilinear functions γⁿ that jointly represent V_{U}ⁿ(b,w), wherein at an end of each said iteration,
determining what action (policy) a∈A should said user execute in decision epoch n∈[0, 1, . . . , N], with wealth level w∈[wₘᵢₙ, wₘₐₓ], given an inventor belief state b(s), for all s∈S.

17. The system as in claim 16, further comprising:
determining whether a bilinear function of said bilinear functions is jointly dominated by other functions; and,
pruning from γⁿ those bilinear functions that are completely dominated by other bilinear functions.

18. The system as in claim 17, wherein said determining whether a function is jointly dominated comprises:
splitting said functions of into functions defined over common wealth interval wₖ₋₁≦w≦wₖ; and,
determining if a feasible solution (b,w) exists for 1≦k≦K according to a first program having quadratic terms; and,
linearizing said first program to obtain a second program having linear terms.

19. The system as in claim 18, wherein said first program is governed according to:
$$max 0 \vert \begin{matrix}{\sum }_{s ∈ S} b ( s ) ( {c}_{i , j , k}^{s} w + {d}_{i , j , k}^{s} ) > 0 & ∀ {υ}_{i} ∈ V \\ {w}_{k - 1} \leq w \leq {w}_{k} & \\ {\sum }_{s ∈ S} b ( s ) = 1 & \end{matrix}$$
where Σ_{s∈S}b(s)(c_{i,j,k}^{s}d_{i,j,k}^{s})>0, υᵢ∈V, is a constraint; and, said second program is governed according to:
$$max 0 \vert \begin{matrix}{\sum }_{s ∈ S} x ( s ) {c}_{i , j , k}^{s} + {b}^{′} ( s ) {d}_{i , j , k}^{s} > 0 & ∀ {υ}_{i} ∈ V \\ {b}^{′} ( s ) {w}_{k - 1} \leq x ( s ) \leq {b}^{′} ( s ) {w}_{k} & ∀ s ∈ S \\ {\sum }_{s ∈ S} {b}^{′} ( s ) = 1 & \end{matrix}$$
where b′ and x are vectors such that, for any feasible solution (b,w), there exists a corresponding feasible solution (b′:=b,x:=bw) , wherein by decreasing a wealth interval, wₖ−wₖ₋₁>0, a probability that a feasible solution (b′,x) implies a feasible solution (b,w) approaches 1 and an error of linearizing approaches 0.

20. The system as in claim 19, further comprising;
tightening a constraint Σ_{s∈S}x(s)c_{i,j,k}^{s}+b′(s)d_{i,j,k}^{s}>0 by a value ε>0 wherein said second program is governed according to:
$$max 0 \vert \begin{matrix}{\sum }_{s ∈ S} x ( s ) {c}_{i , j , k}^{s} + {b}^{′} ( s ) {d}_{i , j , k}^{s} > ɛ & ∀ {υ}_{i} ∈ V \\ {b}^{′} ( s ) {w}_{k - 1} \leq x ( s ) {b}^{′} ( s ) {w}_{k} & ∀ s ∈ S \\ {\sum }_{s ∈ S} {b}^{′} ( s ) = 1 & \end{matrix}$$
resulting in pruning of more functions from V and decreasing method execution time.

21. A computer program product for determining an investment strategy for a risk-sensitive user, the computer program product comprising:
a storage medium readable by a processing circuit and storing instructions for execution by the processing circuit for performing a method comprising:
modeling an user's attitude towards risk as one or more utility functions, said utility functions said utility function transforming a wealth of said user into a utility value;
generating a risk-sensitive Partially Observable-Markov Decision Process (PO-MDP) based on said one or more utility functions; and,
implementing Functional Value Iteration for solving said risk sensitive PO-MDP,
said solution determining an action or policy calculated to maximize an expected total utility of an agent's actions at a particular point in time acting in a partially observable environment.

22. The computer program product as in claim 21, wherein said generating said risk-sensitive PO-MDP comprises:
generating an expected utility function V_{U}ⁿ(b,w) for 0≦n≦N, b∈B, w∈Wⁿ where Wⁿ denotes the set of all possible user wealth levels in decision epoch n; and,
maximizing said expected utility function V_{U} ⁿ(b,w) for a user when commencing action a∈A, where A is a set of Actions, in decision period n in a belief state b with a wealth level w.

23. The computer program product as in claim 22, wherein said expected utility function V_{U}ⁿ(b,w) for executing action a is governed according to:
$${max}_{a ∈ A} \{ {\sum }_{z ∈ Z} P ( z \vert b , a ) {V}_{U}^{n + 1} ( T ( b , a , z ) , w + R ( b , a ) ) \}$$
for all b∈B and w∈Wⁿ and, for all 0≦n≦N, where V_{U}ⁿ⁺¹ is a value function calculated for period n+1; wherein,
P(z|b,a)=Σ_{s′∈S}O(z|a,s′)Σ_{s∈S}P(s′|s,a)b(s) represents a probability of observing z after executing action a from belief state b, where s is a starting state and s′ is a destination state;
R(b,a):=Σ_{s∈S}b(s)R(s,a) is an expected immediate reward that the user receives for executing action a in belief state b; and
T(b,a,z) is the new belief state of the agent after executing action a from belief state b and observed z.

24. The computer program product as in claim 23, further comprising:
iteratively constructing a finite partitioning of a B×W search space into regions where said value functions are represented with point based policies; and
determining from said regions an action.

25. The computer program product as in claim 5, further comprising, at each iteration:
representing V_{U}ⁿ⁺¹(b,w) using a finite set of bilinear functions γⁿ⁺¹; and,
constructing, from said set of bilinear functions from γⁿ⁺¹, a set of bilinear functions γⁿ that jointly represent V_{U}ⁿ(b,w), wherein at an end of each said iteration,
determining from said set of bilinear functions γⁿ what action a∈A should said user execute in decision epoch n∈[0, 1, . . . , N], with wealth level w∈[wₘᵢₙ, wₘₐₓ], given an inventor belief state b(s), for all s∈S.

26. The computer program product as in claim 25, further comprising:
determining whether a bilinear function of said bilinear functions is jointly dominated by other functions; and,
pruning from γⁿ those bilinear functions that are completely dominated by other bilinear functions.
